(19) United States
(12) Patent Application Publication
(10) Pub. No.: US 2025/0317595 A1
(43) Pub. Date: Oct. 9, 2025

(54) CHAINED MOTION VECTOR REFINEMENT

(71) Applicant: Tencent America LLC, Palo Alto, CA (US)

(72) Inventors: Yonguk YOON, Palo Alto, CA (US); Lien-Fei CHEN, Palo Alto, CA (US); Biao WANG, San Jose, CA (US); Ziyue XIANG, Palo Alto, CA (US); Roman CHERNYAK, Santa Clara, CA (US); Tianqi LIU, Palo Alto, CA (US); Motong XU, Palo Alto, CA (US); Shan LIU, San Jose, CA (US); Yifan WANG, Palo Alto, CA (US)

(73) Assignee: Tencent America LLC, Palo Alto, CA (US)

(21) Appl. No.: 19/172,516

(22) Filed: Apr. 7, 2025

Related U.S. Application Data
(60) Provisional application No. 63/631,413, filed on Apr. 8, 2024.
(60) Provisional application No. 63/638,396, filed on Apr. 24, 2024.

(51) Int. Cl. H04N 19/52; H04N 19/139; H04N 19/176

(52) U.S. Cl. CPC H04N 19/52; H04N 19/139; H04N 19/176

(57) ABSTRACT

Some aspects of the disclosure provide a method of video decoding. In an example, a coded video bitstream is received. The coded video bitstream includes coded information of a current block in a current picture. The coded information is determined to indicate a prediction of the current block with a chained vector. The chained vector includes at least a first sub vector and a second sub vector, the first sub vector points to a first reference block with regard to the current block and the second sub vector points to a second reference block with regard to the first reference block. At least a vector offset for refining the chained vector is determined based on at least the first reference block and the second reference block. The current block is reconstructed based on the chained vector and the vector offset.

### INCORPORATION BY REFERENCE

The present application claims the benefit of priority to U.S. Provisional Application No. 63/631,413, filed on Apr. 8, 2024, and U.S. Provisional Application No. 63/638,396, filed on Apr. 24, 2024. The entire disclosures of the prior applications are hereby incorporated by reference in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods and apparatuses for video encoding/decoding. In some examples, an apparatus for video encoding/decoding includes processing circuitry.

Some aspects of the disclosure provide a method of video decoding. In an example, a coded video bitstream is received. The coded video bitstream includes coded information of a current block in a current picture. The coded information is determined to indicate a prediction of the current block with a chained vector. The chained vector includes at least a first sub vector and a second sub vector, the first sub vector points to a first reference block with regard to the current block and the second sub vector points to a second reference block with regard to the first reference block. At least a vector offset for refining the chained vector is determined based on at least the first reference block and the second reference block. The current block is reconstructed based on the chained vector and the vector offset.

Some aspects of the disclosure provide a method for video encoding. In an example, to apply a refinement to a chained vector of a current block in a current picture is determined. The chained vector includes at least a first sub vector and a second sub vector, the first sub vector points to a first reference block with regard to the current block and the second sub vector points to a second reference block with regard to the first reference block. At least a vector offset is determined based on the first reference block and the second reference block. The current block is encoded based on the chained vector and the vector offset.

Some aspects of the disclosure provide a method of video decoding. In an example, a coded video bitstream is received. The coded video bitstream includes coded information of a current block in a current picture. The coded information is determined to indicate a prediction of the current block with a chained vector, the chained vector includes at least a first sub vector and a second sub vector, the first sub vector points to a first reference block with regard to the current block and the second sub vector points to a second reference block with regard to the first reference block. A prediction filter is determined based on the first reference block and the second reference block. The current block is reconstructed based on the chained vector and the prediction filter.

Some aspects of the disclosure provide a method for video encoding. In an example, to evaluate prediction filtering for a chained vector of a current block in a current picture is determined. The chained vector includes at least a first sub vector and a second sub vector, the first sub vector points to a first reference block with regard to the current block and the second sub vector points to a second reference block with regard to the first reference block. A prediction filter is determined based on the first reference block and the second reference block. The current block is encoded based on the chained vector and the prediction filter.

Some aspects of the disclosure provide a method of processing visual media data is provided. In the method, a conversion between a visual media file and a bitstream of visual media data is performed according to a format rule. In an example, the bitstream includes coded information of a current block in a current picture, the coded information of the current block indicates a prediction of the current block based on a chained vector, the chained vector includes at least a first sub vector and a second sub vector, the first sub vector points to a first reference block with regard to the current block and the second sub vector points to a second reference block with regard to the first reference block. The format rule specifies that at least a vector offset is determined based on the first reference block and the second reference block; and the current block is reconstructed based on the chained vector and the vector offset.

Some aspects of the disclosure provide a method of processing visual media data is provided. In the method, a conversion between a visual media file and a bitstream of visual media data is performed according to a format rule. In an example, the bitstream includes coded information of a current block in a current picture, the coded information indicates a prediction of the current block with a chained vector, the chained vector includes at least a first sub vector and a second sub vector, the first sub vector points to a first reference block with regard to the current block and the second sub vector points to a second reference block with regard to the first reference block. The format rule specifies that a prediction filter is determined based on the first reference block and the second reference block; and the current block is reconstructed based on the chained vector and the prediction filter. Aspects of the disclosure also provide an apparatus for video encoding. The apparatus for video encoding including processing circuitry configured to implement any of the described methods for video encoding.

Aspects of the disclosure also provide an apparatus for video decoding. The apparatus for video encoding including processing circuitry configured to implement any of the described methods for video decoding.

Aspects of the disclosure also provide an apparatus for video encoding. The apparatus for video encoding including processing circuitry configured to implement any of the described methods for video encoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system.

FIG. 2 is a schematic illustration of an example of a block diagram of a decoder.

FIG. 3 is a schematic illustration of an example of a block diagram of an encoder.

FIG. 4 shows a diagram of a chained motion vector in some examples.

FIG. 5 shows a diagram of a bi-directional chained motion vector in some examples.

FIG. 6 shows a diagram of a chained block vector in some examples.

FIG. 7 shows a diagram of motion vector refinement for a uni-directional chained motion vector according to an embodiment of the disclosure.

FIG. 8 shows a diagram of motion vector refinement for a bi-directional chained motion vector according to an embodiment of the disclosure.

FIG. 9 shows a diagram of a motion vector refinement for a bi-directional motion vector that includes chained motion vectors according to an embodiment of the disclosure.

FIG. 10 shows a diagram of a motion vector refinement for a bi-directional motion vector that includes chained motion vectors according to an embodiment of the disclosure.

FIG. 11 shows a diagram of techniques for determining a prediction filter for a chained motion vector according to an embodiment of the disclosure.

FIG. 12 shows a diagram of techniques for determining prediction filters for a bi-directional chained motion vector according to an embodiment of the disclosure.

FIG. 13 shows a diagram of techniques for determining a prediction filter for a bi-directional chained motion vector according to an embodiment of the disclosure.

FIG. 14 shows a diagram of techniques for determining a prediction filter for a chained motion vector according to an embodiment of the disclosure.

FIG. 15 shows a flow chart outlining a decoding process according to some aspects of the disclosure.

FIG. 16 shows a flow chart outlining an encoding process according to some aspects of the disclosure.

FIG. 17 shows a flow chart outlining a decoding process according to some aspects of the disclosure.

FIG. 18 shows a flow chart outlining an encoding process according to some aspects of the disclosure.

FIG. 19 is a schematic illustration of a computer system in accordance with an aspect.

### DETAILED DESCRIPTION

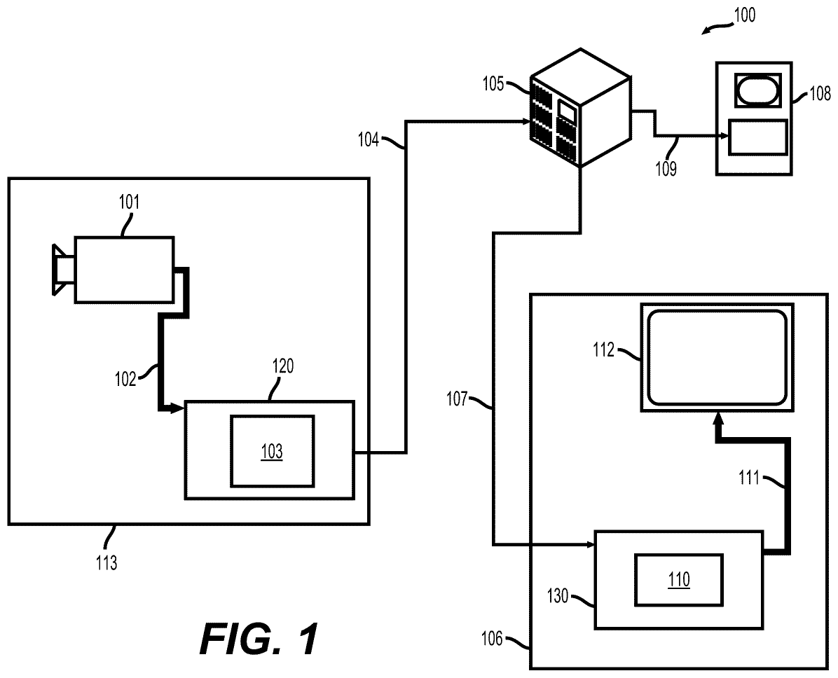

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

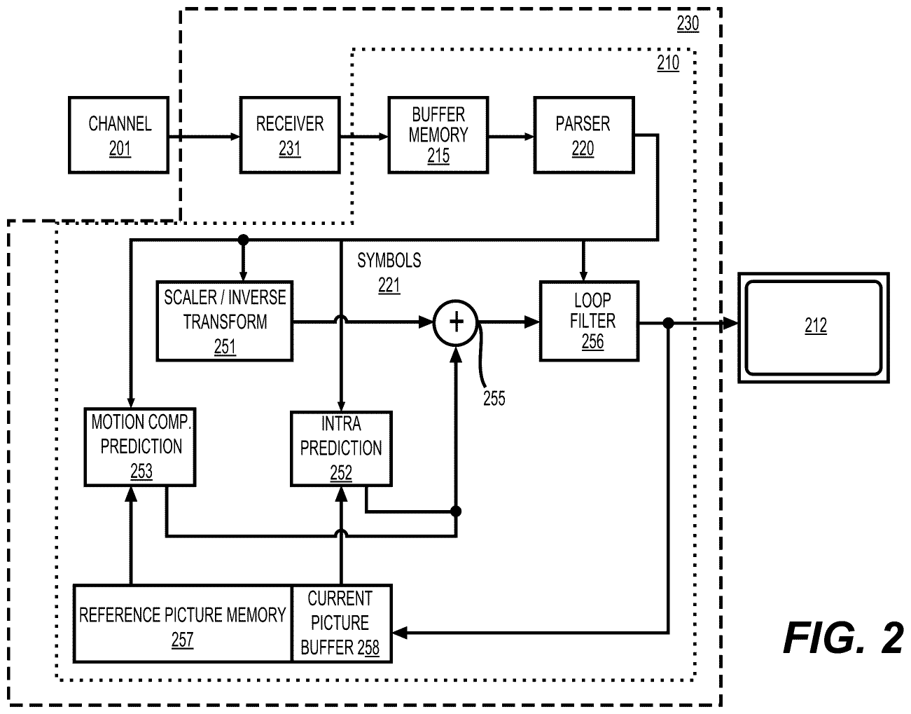

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

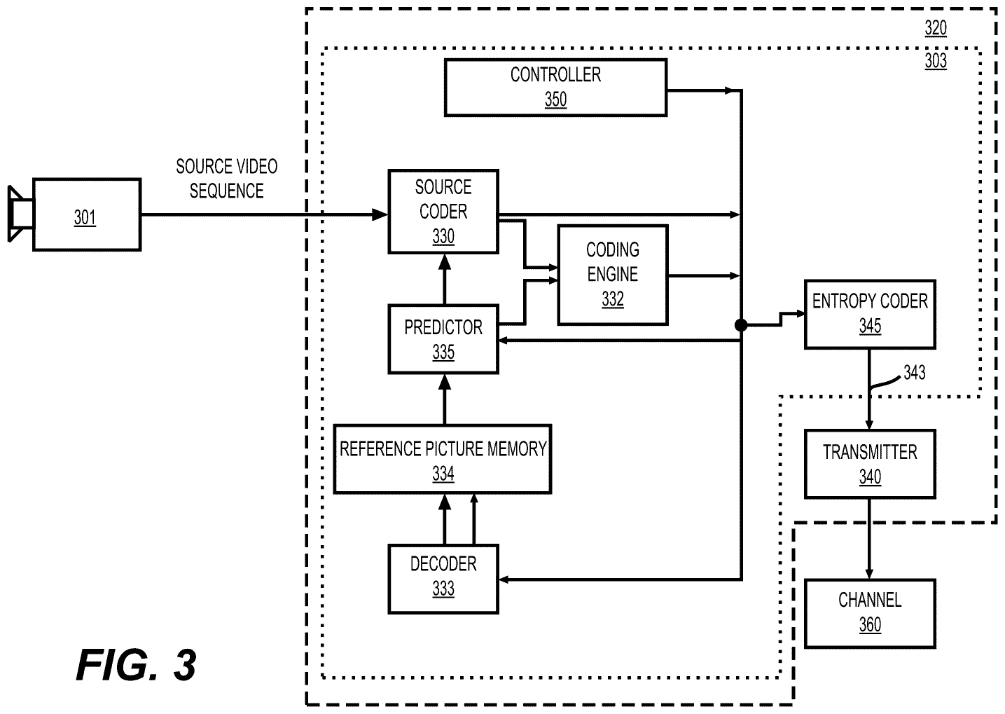

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure provide techniques (e.g., methods, embodiments, encoders, decoders) for chained vector based video coding, such as chained motion vector refinement, prediction filtering based on chained vector, and the like. The techniques in the present disclosure may be used separately or combined in any order. Further, each of the techniques may be implemented by processing circuitry (e.g., one or more processors or one or more integrated circuits). In one example, the one or more processors execute a program that is stored in a non-transitory computer-readable medium. In some examples, a prediction of a current block is based on a chained vector, the chained vector includes at least a first sub vector and a second sub vector, the first sub vector points to a first reference block with regard to the current block and the second sub vector points to a second reference block with regard to the first reference block. Encoder/decoder can determine at least a vector offset for refining the chained vector based on at least the first reference block and the second reference block; and reconstruct the current block based on the chained vector and the vector offset. In some examples, encoder/decoder can determine a prediction filter based on the first reference block and the second reference block; and reconstruct the current block based on the chained vector and the prediction filter.

Video coding has been widely used in many applications. Video coding standards, such as H264, H265, H266 (VVC), AV 1 and AVS, can be adopted in video codec for video coding.

A video codec generally includes several modules, including intra/inter prediction, transform coding, quantization, entropy coding and in loop filtering, etc. Some aspects of the present disclosure provide a set of methods for video compression in the inter prediction coding. In inter prediction coding, motion vectors can be refined. In some examples, a bi-directional prediction block is further refined by optical flow. The technique to refine bi-directional prediction block using optical flow is referred to as bi-directional optical flow (BDOF). The BDOF is used to refine either the motion vector or the prediction signal which is constructed by bi-directional prediction.

In some examples, the techniques can be used on a scenario of a chained vector, such as chained motion vector, chained block vector, and the like. A chained motion vector refers to a motion vector chain which including at least two motion vectors in a sequence, such as a first motion vector and a second motion vector in a sequence. A chained block vector refers to a block vector chain which includes at least two block vectors in a sequence, such as a first block vector and a second block vector in a sequence.

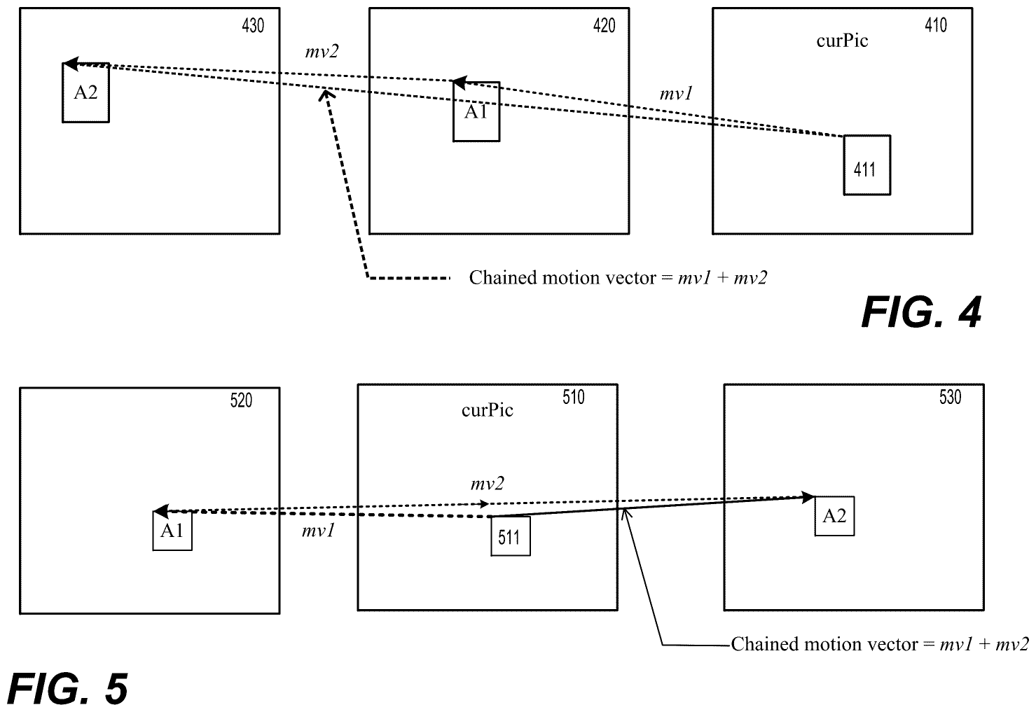

FIG. 4 shows a diagram of a chained motion vector in some examples. In the FIG. 4 example, a current block (411) in a current picture (410) of a video has a first reference block A1 in a first reference picture (420) that is pointed by a first motion vector (mv1) based on the current block (411); and the first reference block A1 in the first reference picture (420) has a second reference block A2 in a second reference picture (430) that is pointed by a second motion vector (mv2) based on the first reference block A1. In the FIG. 4 example, a combination of the first motion vector (mv1) and the second motion vector (mv2) forms a chained motion vector, and the first motion vector (mv1) and the second motion vector (mv2) are referred to as sub motion vectors of the chained motion vector. In some examples, the second reference block A2 is used as a predictor of the current block according to the chained motion vector. In some examples, the current block is predicted according to a combination of the first reference block A1 and the second reference block A2 according to the chained motion vector.

In the FIG. 4 example, both of the first reference picture (420) and the second reference picture (430) are on a same side of the current picture (410) in a display order, the sub motion vectors of the chained motion vector point to the same direction in the display order, the chained motion vector is referred to as a uni-directional chained motion vector. For example, the current picture (410), the first reference picture (420) and the second reference picture (430) are in a display order or a reverse of the display order. In an example, the first reference picture (420) is before the current picture (410) in the display order, the second reference picture (430) is before the first reference picture (420) in the display order. In another example, the first reference picture (420) is after the current picture (410) in the display order, the second reference picture (430) is after the first reference picture (420) in the display order.

It is noted that a chained motion vector can be uni-directional chained motion vector (e.g., as shown in FIG. 4), or can be a bi-directional chained motion vector.

FIG. 5 shows a diagram of a bi-directional chained motion vector in some examples. In the FIG. 5 example, a current block (511) in a current picture (510) of a video has a first reference block A1 in a first reference picture (520) that is pointed by a first motion vector (mv1) based on the current block (511); and the first reference block A1 in the first reference picture (520) has a second reference block A2 in a second reference picture (530) that is pointed by a second motion vector (mv2) based on the first reference block A1. In the FIG. 5 example, a combination of the first motion vector (mv1) and the second motion vector (mv2) forms a chained motion vector, and the first motion vector (mv1) and the second motion vector (mv2) are referred to as sub motion vectors of the chained motion vector. In some examples, the second reference block A2 is used as a predictor of the current block according to the chained motion vector. In some examples, the current block is predicted according to a combination of the first reference block A1 and the second reference block A2 according to the chained motion vector.

In the FIG. 5 example, the first reference picture (520) and the second reference picture (530) are on different sides of the current picture (510) in a display order, the sub motion vectors of the chained motion vector point to different directions in the display order, the chained motion vector is referred to as a bi-directional chained motion vector. In the FIG. 5 example, the first reference picture (520) is before the current picture (510) in the display order, the second reference picture (530) is after the current picture (510) in the display order, and the chained motion vector in the FIG. 5 example is referred to as bi-directional chained motion vector.

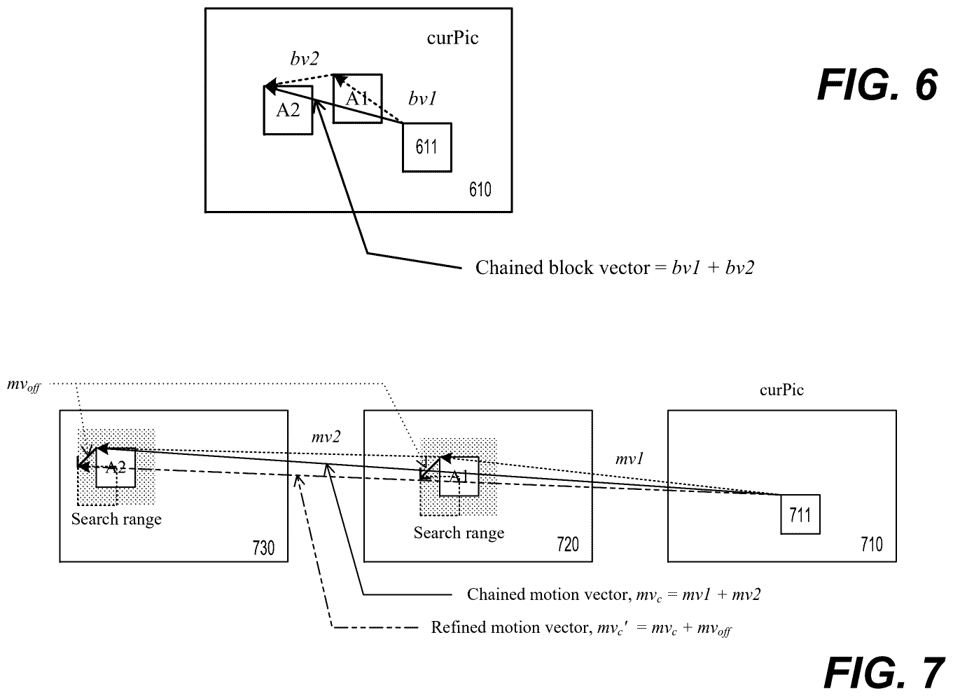

FIG. 6 shows a diagram of a chained block vector in some examples. In the FIG. 6 example, a current block (611) in a current picture (610) of a video has a first reference block A1 in the current picture (610) that is pointed by a first block vector (bv1) based on the current block (611); and the first reference block A1 in the current picture (610) has a second reference block A2 in the current picture (610) that is pointed by a second block vector (bv2) based on the first reference block A1. In the FIG. 6 example, a combination of the first block vector (bv1) and the second block vector (bv2) forms a chained block vector, and the first block vector (bv1) and the second block vector (bv2) are referred to as sub block vectors of the chained block vector. In some examples, the second reference block A2 is used as a predictor of the current block according to the chained block vector. In some examples, the current block is predicted according to a combination of the first reference block A1 and the second reference block A2 according to the chained block vector.

In the present disclosure, while some examples are described based on chained motion vector, the techniques used in the examples can be suitably modified for chained block vector.

According to an aspect of the disclosure, when chained motion vector is used, the current block is similar to both the first reference block and the second reference block, and the current block can be refined using bilateral matching to the first reference block and the second reference block of the chained motion vector.

According to some aspects of the disclosure, motion vector refinement (e.g., uni-directional motion vector refinement, bi-directional motion vector refinement, and the like) is utilized to refine chained motion vector of the current block. When a motion vector of the current block is a chained motion vector, the reference blocks (e.g., A1 and A2) from (pointed by) sub motion vectors of the chained motion vector are employed for the bilateral matching.

In some examples, for the uni-directional bilateral matching, a block searching process is conducted with motions (motion offsets) in the same direction on, for example two reference blocks, the motion offsets can be searched in a search range to find a motion vector offset (mv_{off}) of the best cost between the two reference blocks. The final motion vector (mv_{c}′) is constructed by adding motion vector offset (mv_{off}) to the chained motion vector (mv_{c}).

In some aspects, the current block can have one or more chained motion vectors. In an example, the current block has one chained motion vector. In another example, the current block is a bi-prediction block, and has a first chained motion vector in a first direction of the display order, and has a second chained motion vector in a second direction of the display order.

In some aspects, a chained motion vector includes more than one motion vectors as sub motion vectors. In some examples, a chained motion vector has two sub motion vectors. In some examples, a chained motion vector has more than two sub motion vectors.

In some examples, when sub motion vectors point to uni-direction, a block searching process can be performed with the same direction motion on both reference blocks to find the best matched block using bilateral matching between reference blocks. One motion vector offset is derived corresponding to the best matched block. The motion vector offset is added to the chained motion vector.

FIG. 7 shows a diagram of motion vector refinement for a uni-directional chained motion vector according to an embodiment of the disclosure.

In the FIG. 7 example, a current block (711) in a current picture (710) of a video has a first reference block A1 in a first reference picture (720) that is pointed by a first motion vector (mv1) based on the current block (711); and the first reference block A1 in the first reference picture (720) has a second reference block A2 in a second reference picture (730) that is pointed by a second motion vector (mv2) based on the first reference block A1. In the FIG. 7 example, a combination of the first motion vector (mv1) and the second motion vector (mv2) forms a chained motion vector. In the FIG. 7 example, the sub motion vectors (mv1 and mv2) point the same direction, and the chained motion vector is referred to as uni-directional chained motion vector.

Further, in the FIG. 7 example, a search range is defined about the first reference block A1 and the second reference block A2, a block searching process is conducted with motions (potential motion offsets) in the same direction on the first reference block A1 and the second reference block A2. In an example, the motion offsets can be searched in the search range to find a motion vector offset (mv_{off}) of the best cost between the two reference blocks A1 and A2. In an example, for a potential motion offset, two potential refined reference blocks A1′ and A2′ can be determined, and a cost value, such as a sum of absolute difference (SAD), associated with the potential motion offset is calculated based on sample differences of the two potential refined reference blocks A1′ and A2′. Among cost values associated with the potential motion offsets, a lowest cost value can be found and the potential motion offset associated with the lowest cost value can be determined as the motion vector offset (mv_{off}) of the best cost. The final motion vector (mv_{c}′) is constructed by adding motion vector offset (mv_{off}) to the chained motion vector (mv_{c}).

As shown in the FIG. 7 example, when sub motion vectors (mv1 and mv2) point uni-direction, during block search using one motion vector offset (mv_{off}), bilateral block matching between reference blocks (A1 and A2) is performed to find the best matched block. A refined motion vector (mv_{c}′) is derived by adding one motion vector offset (mv_{off}) to the chained motion vector (mv_{c}).

In some examples, when sub motion vectors point bi-direction, a block searching process can be performed with the mirrored direction motion on both reference blocks to find the best matched block using bilateral matching between reference blocks. One motion vector offset is derived corresponding to the best matched block. The motion vector offset is added to the chained motion vector.

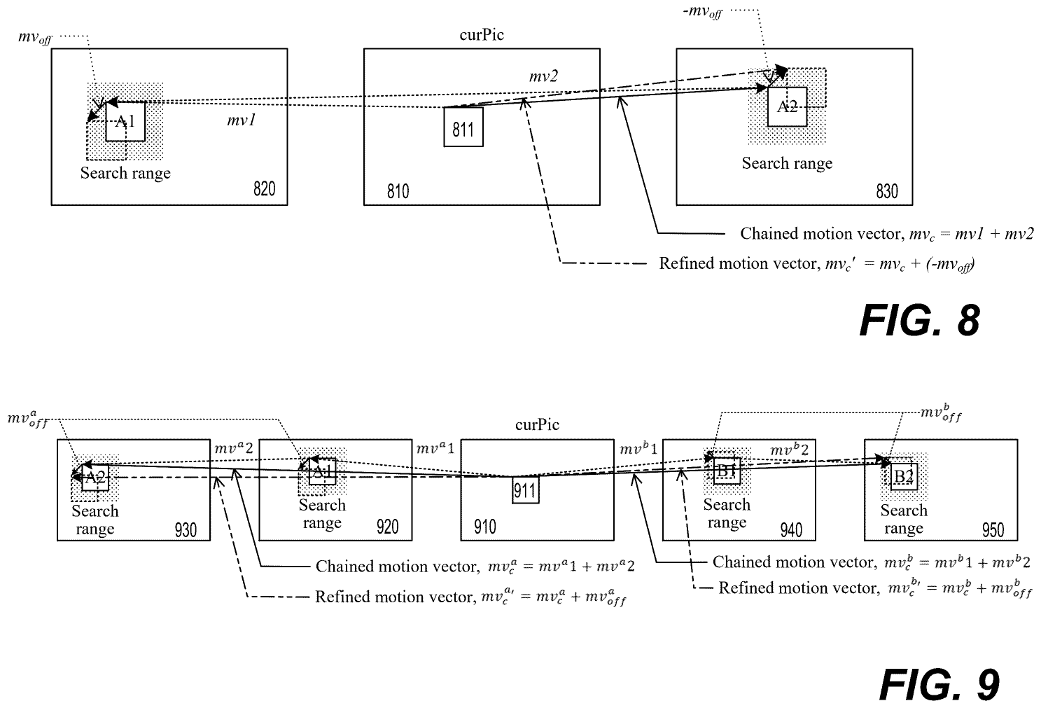

FIG. 8 shows a diagram of motion vector refinement for a bi-directional chained motion vector according to an embodiment of the disclosure. In the FIG. 8 example, a current block (811) in a current picture (810) of a video has a first reference block A1 in a first reference picture (820) that is pointed by a first motion vector (mv1) based on the current block (811); and the first reference block A1 in the first reference picture (820) has a second reference block A2 in a second reference picture (830) that is pointed by a second motion vector (mv2) based on the first reference block A1. In the FIG. 8 example, a combination of the first motion vector (mv1) and the second motion vector (mv2) forms a chained motion vector.

In the FIG. 8 example, the first reference picture (820) and the second reference picture (830) are on different sides of the current picture (810) in a display order, the sub motion vectors of the chained motion vector point to different directions in the display order, the chained motion vector is referred to as a bi-directional chained motion vector. In the FIG. 8 example, the first reference picture (820) is before the current picture (810) in the display order, the second reference picture (830) is after the current picture (810) in the display order, and the chained motion vector in the FIG. 8 example is referred to as bi-directional chained motion vector.

Further, in the FIG. 8 example, a search range is defined about the first reference block A1 and the second reference block A2, a block searching process is conducted with motions (e.g., potential motion offsets) in the mirrored directions on the first reference block A1 and the second reference block A2 (e.g., when a potential motion offset is applied on the first reference block A1, and an opposite of the potential motion offset is applied on the second reference block A2). In an example, the motion offsets can be searched in the search range to find a motion vector offset (mv_{off}) of the best cost between the two reference blocks A1 and A2. In an example, for a potential motion offset, two potential refined reference blocks A1′ (e.g., the potential motion offset is applied to get the potential refined reference block A1′) and A2′ (e.g., an opposite of the potential motion offset is applied to get the potential refined reference block A2′) can be determined, and a cost value, such as a sum of absolute difference (SAD), associated with the potential motion offset is calculated based on sample differences of the two potential refined reference blocks A1′ and A2′. Among cost values associated with the potential motion offsets, a lowest cost value can be found and the potential motion offset associated with the lowest cost value can be determined as the motion vector offset (mv_{off}) of the best cost. The final motion vector (mv_{c}′) is constructed by adding the opposite of motion vector offset (−mv_{off}) to the chained motion vector (mv_{c}).

In the FIG. 8 example, the sub motion vectors (mv1 and mv2) point bi-direction, during block search using one motion vector offset (mv_{off}), bilateral block matching between reference blocks (A1 and A2) is performed to find the best matched block where the motion vector offset (mv_{off}) is used for the ‘A1’ reference blocks while the opposite the motion vector offset (−mv_{off}) is used for the ‘A2’ reference blocks. A refined motion vector (mv_{c}′) is derived by adding one motion vector offset (−mv_{off}) to the chained motion vector (mv_{c}).

In some aspects, the current block is predicted based on a bi-directional motion vector with motion vectors respectively point to reference pictures on two directions, at least one of the motion vectors is a uni-directional chained motion vector. A motion vector offset corresponding to each uni-directional chained motion vector can be applied.

FIG. 9 shows a diagram of a motion vector refinement for a bi-directional motion vector that includes chained motion vectors according to an embodiment of the disclosure.

In the FIG. 9 example, a current block (911) in a current picture (910) of a video is predicted based on a bi-directional motion vector that includes two chained motion vectors. The two chained motion vectors are respectively uni-directional chained motion vectors, but point to different directions in the display order.

Specifically, the current block (911) has a first chained motion vector mv_{c}^{a} and a second chained motion vector mv_{c}^{b}.

For the first chained motion vector mv_{c}^{a}, the current block (911) has a first reference block A1 in a first reference picture (920) that is pointed by a first motion vector (mv^{a}1) based on the current block (911); and the first reference block A1 in the first reference picture (920) has a second reference block A2 in a second reference picture (930) that is pointed by a second motion vector (mv^{a}2) based on the first reference block A1.

For the second chained motion vector mv_{c}^{b}, the current block (911) has a third reference block B1 in a third reference picture (940) that is pointed by a third motion vector (mv^{b}1) based on the current block (911); and the third reference block B1 in the third reference picture (940) has a fourth reference block B2 in a fourth reference picture (950) that is pointed by a fourth motion vector (mv^{b}2) based on the third reference block B1.

In the FIG. 9 example, for each directional chained motion vector, uni-directional motion vector refinement can be applied. Motion vector offsets (mv_{off}^{a} and mv_{off}^{b}) are derived separately by bilateral block matching in reference blocks corresponding to each directional chained motion vector. The derived motion vector offsets are added to each chained motion vector, respectively.

Specifically, for the first chained motion vector mv_{c}^{a}, in the FIG. 9 example, a search range is defined about the first reference block A1 and the second reference block A2, a block searching process is conducted with motions (potential motion offsets) in the same direction on the first reference block A1 and the second reference block A2. In an example, the motion offsets can be searched in the search range to find a motion vector offset (mv_{off}^{a}) of the best cost between the two reference blocks A1 and A2. In an example, for a potential motion offset, two potential refined reference blocks A1′ and A2′ can be determined, and a cost value, such as a sum of absolute difference (SAD), associated with the potential motion offset is calculated based on sample differences of the two potential refined reference blocks A1′ and A2′. Among cost values associated with the potential motion offsets, a lowest cost value can be found and the potential motion offset associated with the lowest cost value can be determined as the motion vector offset (mv_{off}^{a}) of the best cost. The final first motion vector (mv_{c}^{a}′) is constructed by adding motion vector offset (mv_{off}^{a}) to the first chained motion vector (mv_{c}^{a}).

For the second chained motion vector mv_{c}^{b}, in the FIG. 9 example, a search range is defined about the third reference block B1 and the fourth reference block B2, a block searching process is conducted with motions (potential motion offsets) in the same direction on the third reference block B1 and the fourth reference block B2. In an example, the motion offsets can be searched in the search range to find a motion vector offset (mv_{off}^{b}) of the best cost between the two reference blocks B1 and B2. In an example, for a potential motion offset, two potential refined reference blocks B1′ and B2′ can be determined, and a cost value, such as a sum of absolute difference (SAD), associated with the potential motion offset is calculated based on sample differences of the two potential refined reference blocks B1′ and B2′. Among cost values associated with the potential motion offsets, a lowest cost value can be found and the potential motion offset associated with the lowest cost value can be determined as the motion vector offset (mv_{off}^{b}) of the best cost. The final second motion vector (mv_{c}^{b}′) is constructed by adding motion vector offset (mv_{off}^{b}) to the second chained motion vector (mv_{c}^{b}).

In some aspects, when the current block has chained bi-directional motion vectors where at least one motion vector is a chained motion vector, one motion vector offset of the same amplitude but different direction can be applied to the bi-directional chained motion vector.

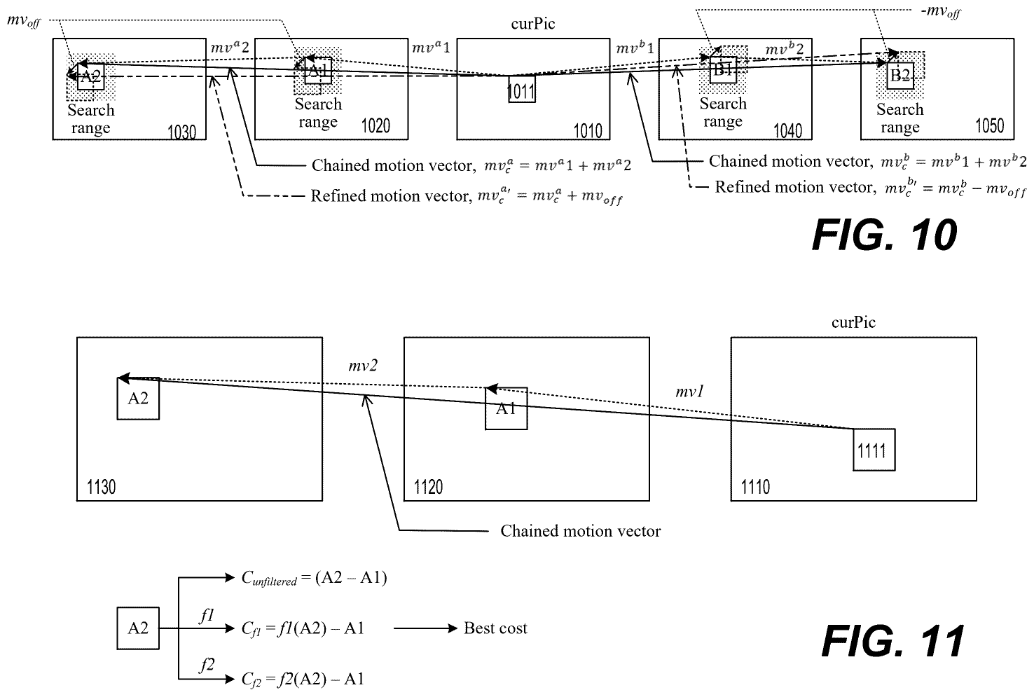

FIG. 10 shows a diagram of a motion vector refinement for a bi-directional motion vector that includes chained motion vectors according to an embodiment of the disclosure.

In the FIG. 10 example, a current block (1011) in a current picture (1010) of a video is predicted based on a bi-directional motion vector that includes two chained motion vectors. The two chained motion vectors are respectively uni-directional chained motion vectors, but point to different directions in the display order.

Specifically, the current block (1011) has a first chained motion vector mv_{c}^{a} and a second chained motion vector mv_{c}^{b}.

For the first chained motion vector mv_{c}^{a}, the current block (1011) has a first reference block A1 in a first reference picture (1020) that is pointed by a first motion vector (mv^{a}1) based on the current block (1011); and the first reference block A1 in the first reference picture (1020) has a second reference block A2 in a second reference picture (1030) that is pointed by a second motion vector (mv^{a}2) based on the first reference block A1.

For the second chained motion vector mv^{b}, the current block (1011) has a third reference block B1 in a third reference picture (1040) that is pointed by a third motion vector (mv^{b}1) based on the current block (1011); and the third reference block B1 in the third reference picture (1040) has a fourth reference block B2 in a fourth reference picture (1050) that is pointed by a fourth motion vector (mv^{b}2) based on the third reference block B1.

In the FIG. 10 example, for both directional chained motion vectors, one motion vector offset (mv_{off}) is derived by bilateral block matching using whole reference blocks (including reference blocks A1, A2, B1, and B2) of all sub-motion vectors of chained motion vectors. For the ‘A’ reference blocks, the motion vector offset (mv_{off}) is used while for the ‘B’ reference blocks the opposite motion vector offset (−mv_{off}) is used to find the best cost block.

Specifically, in the FIG. 10 example, a search range is defined about the first reference block A1, the second reference block A2, the third reference block B1, the fourth reference block B2, a block searching process is conducted with motions (potential motion offsets) in a first direction on the first reference block A1 and the second reference block A2, and in a second direction on the third reference block B1 and the fourth reference block B2. The first direction and the second direction are opposite to each other. In an example, the motion offsets can be searched in the search range to find a motion vector offset (mv_{off}) of the best cost of the reference blocks A1, A2, B1 and B2. In an example, for a potential motion offset, four potential refined reference blocks A1′, A2′, B1′ and B2′ can be determined, and a cost value associated with the potential motion offset is calculated based on the four potential refined reference blocks A1′, A2′, B1′ and B2′. In an example, the cost value is a sum of a first sub cost value and a second sub cost value. The first sub cost value is calculated based on sample differences of the two potential refined reference blocks A1′ and A2′, and the second sub cost value is calculated based on sample differences of the two potential refined reference blocks B1′ and B2′. Among cost values associated with the potential motion offsets, a lowest cost value can be found and the potential motion offset associated with the lowest cost value can be determined as the motion vector offset (mv_{off}) of the best cost. The final motion vectors (mv_{c}^{a}′ and mv_{c}^{a}″) can be constructed by adding motion vector offset (mv_{off}) to the first chained motion vector (mv_{c}^{a}), and adding the opposite motion vector offset (−mv_{off}) to the second chained motion vector (mv_{c}).

According to an aspect, the chained motion refinement can be applied according to block shape, block size, and other coding information. For example, when the block shape of the current block satisfies a requirement, the refinement of the chained motion vector can be applied to the current block. In another example, when the block size of the current block satisfies a requirement, the refinement of the chained motion vector can be applied to the current block.

In an aspect, whether the chained motion vector refinement is applied can be determined when the difference between reference blocks is smaller than specified threshold. In an example, when an SAD cost value between the two reference blocks (pointed by the first sub motion vector and the second sub motion vector within the chained motion vector) is smaller than a specified threshold, chained motion vector refinement (refinement on chained motion vector) is not applied.

Some aspects of the disclosure also provide techniques to derive a prediction filter for a current block with a chained vector for prediction. The chained vector has a plurality of reference blocks. The chained vector can be a chained motion vector including a plurality of sub motion vectors or can be a chained block vector including a plurality of sub block vectors. In some examples, the prediction filter is derived from at least two prediction blocks associated with the chained vector and the derived prediction filter is applied to the reference block which is used to generate a predictor of the current block.

It is noted that when the chained vector is used for the current block, at least two reference blocks exist as shown in FIG. 4, FIG. 5 and FIG. 6. In some aspects, a prediction filter can be determined from a filter set based on the cost calculated between reference blocks. The prediction filter with the best cost is applied to the reference block used as the predictor of the current block.

In some examples, the filter set can include at least one prediction filter.

In some examples, the filter set can include one or more linear filters. In some examples, the filter set can include one or more non-linear filters. In some examples, the filter set can include predefined filters, such as a sharpening filter, a smoothing filter, a bilateral filter, and the like.

In some examples, the filter set can include a regression-based filter that is derived from reference blocks based on a regression technique.

According to some aspects of the disclosure, the prediction filter can be determined based on the cost values that are calculated between unfiltered/filtered reference block and unfiltered reference block.

FIG. 11 shows a diagram of techniques for determining a prediction filter for a chained motion vector according to an embodiment of the disclosure.

In the FIG. 11 example, a current block (1111) in a current picture (1110) is predicted based on a chain motion vector including a first sub motion vector (mv1) and a second sub motion vector (mv2). The current block (1111) in the current picture (1110) has a first reference block A1 in a first reference picture (1120) that is pointed by the first sub motion vector (mv1) based on the current block (1111); and the first reference block A1 in the first reference picture (1120) has a second reference block A2 in a second reference picture (1130) that is pointed by the second sub motion vector (mv2) based on the first reference block A1.

In some examples, a prediction filter is selected from a filter set based on the cost values associated with filters in the filter set. The cost values are calculated between unfiltered/filtered second reference block and unfiltered first reference block in some examples.

For example, as shown in FIG. 11, the filter set includes a first filter (e.g., sharpening filter) that is denoted by f1, and a second filter (e.g., smoothing filter) that is denoted by f2. In an example, an unfiltered cost value is calculated between unfiltered second reference block A2 and unfiltered first reference block A1, such as sum of absolute differences between sample values of the unfiltered second reference block A2 and the unfiltered first reference block A1, the unfiltered cost value is denoted by C_{unfiltered}.

Further, filtered cost values are calculated between filtered reference block A2 denoted by f(A2) and the unfiltered reference block A1. For example, a first filtered cost value (denoted by Cf) is calculated between filtered second reference block by the first filter f1(A2) and unfiltered first reference block A1, such as sum of absolute differences between sample values of the filtered second reference block f1(A2) and the unfiltered first reference block A1; a second filtered cost value (denoted by Cⱼ₂) is calculated between filtered second reference block by the second filter f2(A2) and unfiltered first reference block A1, such as sum of absolute differences between sample values of the filtered second reference block f2(A2) and the unfiltered first reference block A1.

Further, in the FIG. 11 example, the unfiltered cost value and the two filtered cost values are compared, and the best cost (lowest cost value) is determined. When the best cost is from the unfiltered cost value, no prediction filter is needed. When the best cost is from the first unfiltered cost value C_{f1}, the first filter is determined to be the prediction filter for the current block. When the best cost is from the second filtered cost value C_{f2}, the second filter is determined to be the prediction filter for the current block. In some examples, the second reference block is used to generate a prediction block for the current block, and the prediction filter is applied on the second reference block. The filtered second reference block is used for further motion compensation in an example.

In some examples, the current block has bi-directional chained motion vectors where at least one motion vector is a chained motion vector, prediction filters can be determined respectively for each motion vector.

In an example, when the motion vector of the current block is bi-directional chained motion vector, the bi-directional chained motion vector includes two chained motion vectors, and two prediction filters can be separately determined for the two chained motion vectors.

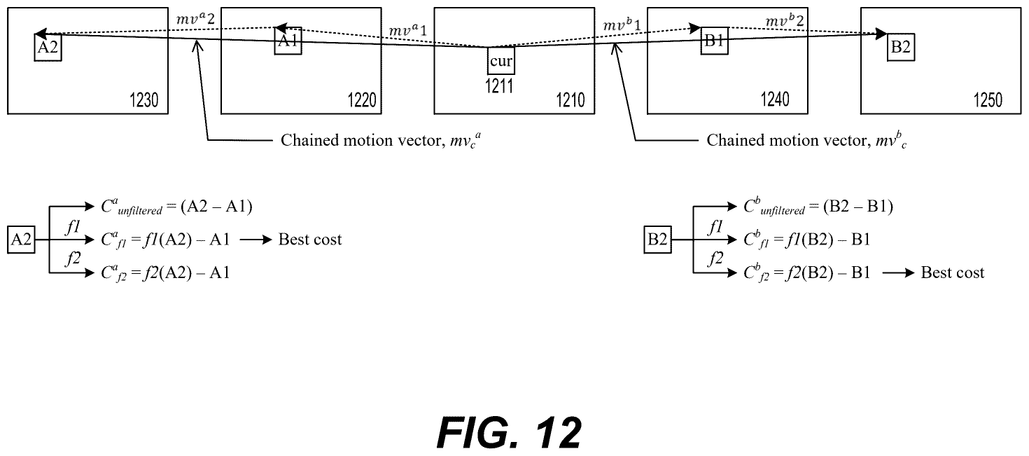

FIG. 12 shows a diagram of techniques for determining prediction filters for a bi-directional chained motion vector according to an embodiment of the disclosure.

In the FIG. 12 example, a current block (1211) in a current picture (1210) of a video is predicted based on a bi-directional motion vector that includes two chained motion vectors. The two chained motion vectors are respectively uni-directional chained motion vectors, but point to different directions in the display order.

Specifically, the current block (1211) has a first chained motion vector mv_{c}^{a} and a second chained motion vector mv_{c}^{b}.

For the first chained motion vector mv_{c}^{a}, the current block (1211) has a first reference block A1 in a first reference picture (1220) that is pointed by a first motion vector (mv^{a}1) based on the current block (1211); and the first reference block A1 in the first reference picture (1220) has a second reference block A2 in a second reference picture (1230) that is pointed by a second motion vector (mv^{a}2) based on the first reference block A1.

For the second chained motion vector mv^{b}, the current block (1211) has a third reference block B1 in a third reference picture (1240) that is pointed by a third motion vector (mv^{b}1) based on the current block (1211); and the third reference block B1 in the third reference picture (1240) has a fourth reference block B2 in a fourth reference picture (1250) that is pointed by a fourth motion vector (mv^{b}2) based on the third reference block B1.

In the FIG. 12 example, for each uni-directional chained motion vector, a prediction filter is determined separately.

Specifically, for the first chained motion vector mv_{c}^{a}, in the FIG. 12 example, the filter set includes a first filter f1, and a second filter f2. In an example, an unfiltered cost value C^{a}_{unfiltered} is calculated based on unfiltered second reference block A2 and unfiltered first reference block A1.

Further, a first filtered cost value denoted by C^{a}_{f1} is calculated between filtered second reference block by the first filter f1(A2) and unfiltered first reference block A1; a second filtered cost value C^{a}_{f2} is calculated between filtered second reference block by the second filter f2(A2) and unfiltered first reference block A1.

In the FIG. 12 example, the first filtered cost value C^{a}_{f1} is lower than the unfiltered cost value C^{a}_{unfiltered} and the second filtered cost value C^{a}_{f2}. The first filter is selected as the prediction filter for the first chained motion vector mv_{c}^{a}. In some examples, the second reference block is used to generate a prediction block for the current block according to the first chained motion vector mv_{c}^{a}, and the first filter is applied on the second reference block. The filtered second reference block is used for further motion compensation in an example.

Also, in the FIG. 12 example, for the second chained motion vector mv_{c}^{b}, the filter set includes the first filter f1, and the second filter f2. In an example, an unfiltered cost value C^{b}_{unfiltered} is calculated based on unfiltered fourth reference block B2 and unfiltered third reference block B1.

Further, a third filtered cost value denoted by C^{b}_{f1} is calculated between filtered fourth reference block by the first filter f1(B2) and unfiltered third reference block B1; a fourth filtered cost value C^{b}_{f2} is calculated between filtered fourth reference block by the second filter f2(B2) and unfiltered third reference block B1.

In the FIG. 12 example, the fourth filtered cost value C^{b}_{f1} is lower than the unfiltered cost value C^{b}_{unfiltered} and the third filtered cost value Con. The second filter is selected as the prediction filter for the second chained motion vector mv_{c}^{b}. In some examples, the fourth reference block is used to generate a prediction block for the current block according to the second chained motion vector mv_{c}^{b}, and the second filter is applied on the fourth reference block. The filtered fourth reference block is used for further motion compensation in an example.

In some aspects, when the chained vector has two motion vectors, a prediction filter can be derived for both chained motion vectors.

In an example, when the motion vector of the current block is bi-directional chained motion vector, the bi-directional chained motion vector includes two chained motion vectors, and one prediction filter can be determined for both of the two chained motion vectors.

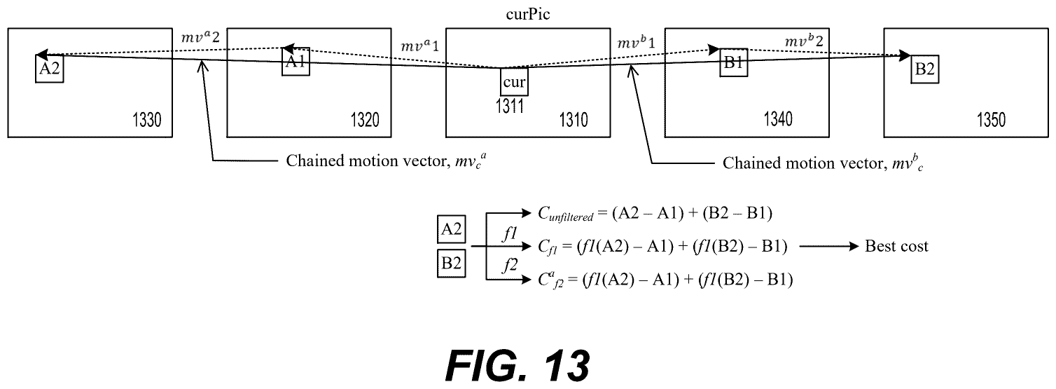

FIG. 13 shows a diagram of techniques for determining a prediction filter for a bi-directional chained motion vector according to an embodiment of the disclosure.

In the FIG. 13 example, a current block (1311) in a current picture (1310) of a video is predicted based on a bi-directional motion vector that includes two chained motion vectors. The two chained motion vectors are respectively uni-directional chained motion vectors, but point to different directions in the display order.

Specifically, the current block (1311) has a first chained motion vector mv_{c}^{a} and a second chained motion vector mv_{c}^{b}.

For the first chained motion vector mv_{c}^{a}, the current block (1311) has a first reference block A1 in a first reference picture (1320) that is pointed by a first motion vector (mv^{a}1) based on the current block (1311); and the first reference block A1 in the first reference picture (1320) has a second reference block A2 in a second reference picture (1330) that is pointed by a second motion vector (mv^{a}2) based on the first reference block A1.

For the second chained motion vector mv_{c}^{b}, the current block (1311) has a third reference block B1 in a third reference picture (1340) that is pointed by a third motion vector (mv^{b}1) based on the current block (1311); and the third reference block B1 in the third reference picture (1340) has a fourth reference block B2 in a fourth reference picture (1350) that is pointed by a fourth motion vector (mv^{b}2) based on the third reference block B1.

In the FIG. 13 example, for the bi-directional chained motion vector that includes two uni-directional chained motion vectors, a prediction filter is determined for the two uni-directional chained motion vectors.

As shown in FIG. 13, the filter set includes a first filter (e.g., sharpening filter) f1 and a second filter (e.g., smoothing filter) f2. An unfiltered cost value is calculated between unfiltered reference blocks. Filtered cost values are calculated between filtered two reference blocks (f(A2), f(B2)) by the filter set wherein the same filter is applied to both reference blocks (A2, B2) and unfiltered reference block (A1, B1) as the filtered costs.

Specifically, in an example, an unfiltered cost value C_{unfiltered} is calculated based on the unfiltered first reference block A1, the unfiltered second reference block A2, the unfiltered third reference block B1, and the unfiltered fourth reference block B2. For example, the unfiltered cost value C_{unfiltered} is a sum of a first sub unfiltered cost value and a second sub unfiltered cost value. For example, the first sub unfiltered cost value is calculated as a sum of absolute difference of sample differences between unfiltered second reference block A2 and unfiltered first reference block A1; and the second sub unfiltered cost value is calculated as a sum of absolute difference of sample differences between unfiltered fourth reference block B2 and unfiltered third reference block A1.

Further, two filtered cost values associated with the first filter and the second filter in the filter set are calculated.

In an example, the first filtered cost value associated with the first filter C_{f1} is calculated based on the unfiltered first reference block A1, the filtered second reference block by the first filter f1(A2), the unfiltered third reference block B1, and the filtered fourth reference block by the first filter f1(B2). For example, the first filtered cost value C_{f1} is a sum of a first sub filtered cost value and a second sub filtered cost value. For example, the first sub filtered cost value is calculated as a sum of absolute difference of sample differences between the filtered second reference block f1(A2) and unfiltered first reference block A1; and the second sub unfiltered cost value is calculated as a sum of absolute difference of sample differences between filtered fourth reference block f1(B2) and unfiltered third reference block B1.

Further, in an example, the second filtered cost value associated with the second filter C_{f2} is calculated based on the unfiltered first reference block A1, the filtered second reference block by the second filter f2(A2), the unfiltered third reference block B1, and the filtered fourth reference block by the second filter f2(B2). For example, the second filtered cost value C_{f2} is a sum of a third sub filtered cost value and a fourth sub filtered cost value. For example, the third sub filtered cost value is calculated as a sum of absolute difference of sample differences between the filtered second reference block f2(A2) and unfiltered first reference block A1; and the fourth sub unfiltered cost value is calculated as a sum of absolute difference of sample differences between filtered fourth reference block f2(B2) and unfiltered third reference block B1.

In the FIG. 13 example, the unfiltered cost value C_{unfiltered} and the two filtered cost values C_{f1} and C_{f2} are compared, and the best cost (lowest cost value) is determined. When the best cost is from the unfiltered cost value C_{unfiltered}, no prediction filter is needed. When the best cost is from the first unfiltered cost value Cf, the first filter is determined to be the prediction filter for both of the two chained motion vectors. When the best cost is from the second filtered cost value C_{f2}, the second filter is determined to be the prediction filter for both of the two chained motion vectors. In some examples, the second reference block A2 and the fourth reference block B2 are used to generate a predictor for the current block, and the prediction filter is applied on the second reference block A2 and the fourth reference block B2.

It is noted that when the chained vector is used for the current block, at least two reference blocks exist as shown in FIG. 4, FIG. 5 and FIG. 6. A prediction filter (model) can be derived using the reference blocks and applied to the reference block.

In some examples, the prediction filter is a linear filter or a non-linear filter and is derived using the linear regression-based method to derive the linear equation or non-linear equation according to the two reference blocks, such as the first reference block A1 and the second block A2. Then, the derived prediction filter can be applied on the reference block which is used to generate a prediction block for the current block.

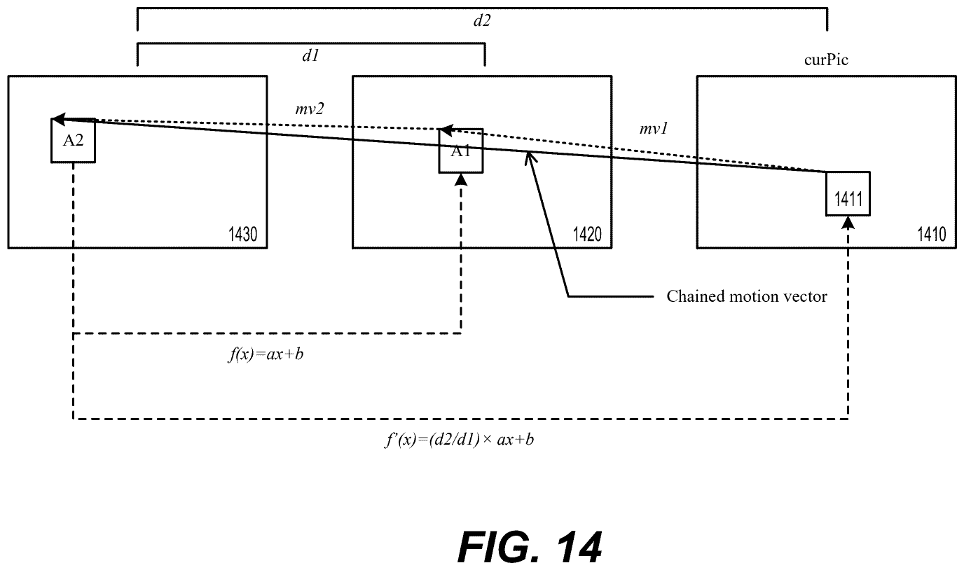

FIG. 14 shows a diagram of techniques for determining a prediction filter for a chained motion vector according to an embodiment of the disclosure.

In the FIG. 14 example, a current block (1411) in a current picture (1410) is predicted based on a chain motion vector including a first sub motion vector (mv1) and a second sub motion vector (mv2). The current block (1411) in the current picture (1410) has a first reference block A1 in a first reference picture (1420) that is pointed by the first sub motion vector (mv1) based on the current block (1411); and the first reference block A1 in the first reference picture (1420) has a second reference block A2 in a second reference picture (1430) that is pointed by the second sub motion vector (mv2) based on the first reference block A1.

In an example, a prediction filter f(x) is a linear filter (also referred to as linear model, linear function) that is represented by f(x)=ax+b, where a and b are the filter coefficients. The filter coefficients can be derived according to the first reference block A1 and the second block A2 using the linear regression-based method. For example, the linear filter (also referred to as linear model, linear function) with to be determined filter coefficients is applied to the second reference block to obtain filtered second reference block, and the difference (e.g., SAD) of the filtered second reference block and the first reference block is calculated, and the filter coefficients are determined using the linear regression based method to minimize the difference. Then, the derived prediction filter f(x) (with the determined filter coefficients) can be applied on the second reference block which is used to generate a prediction block for the current block.

In some aspects, the derived prediction filter can be scaled according to distance between the reference picture and the current picture.

In the FIG. 14 example, the distance between the first reference block A1 and the second reference block A2 is denoted by d1, the distance between the second reference block A2 and the current block is denoted by d2. In an example, the prediction filter f(x) can be scaled according to a distance ratio (e.g., d2/d1) to derive a scaled filter

$${f}^{′} ( x ) = \frac{d 2}{d 1} \times ( ax + b ) .$$

In another example, the offset b of the prediction filter f(x) is not scaled, and only the scaling factor a is scaled according to the distance ratio (e.g., d2/d1), and the scaled filter is represented by

$${f}^{′} ( x ) = \frac{d 2}{d 1} \times ax + b .$$

In some examples, when the motion vector of a current block is bi-directional chained motion vector, the bi-directional chained motion vector includes two chained motion vectors, and two prediction filters can be separately derived respectively for the two chained motion vectors.

In some examples, when the motion vector of a current block is bi-directional chained motion vector, the bi-directional chained motion vector includes two chained motion vectors, and a prediction filter can be derived for the two chained motion vectors.

In some aspects, the prediction filter can be applied either before or after motion compensation. In an example, when a prediction block is generated based on the reference block, the prediction filter is applied on the prediction block before further motion compensation is applied. In another example, when a prediction block is generated based on the reference block, certain motion compensation is applied on the prediction block, and then the prediction filter is applied after the motion compensation. The motion compensation includes, but not limit to, DMVR, BDOF and the like.

In some aspects, the prediction filter can be applied either before or after an interpolation filter of each reference block in each reference list. In an example, the prediction filter can be applied before an application of an interpolation filter to generate a prediction block for fractional positions. In another example, the prediction filter can be applied after an application of an interpolation filter to generate a prediction block for the fractional positions.

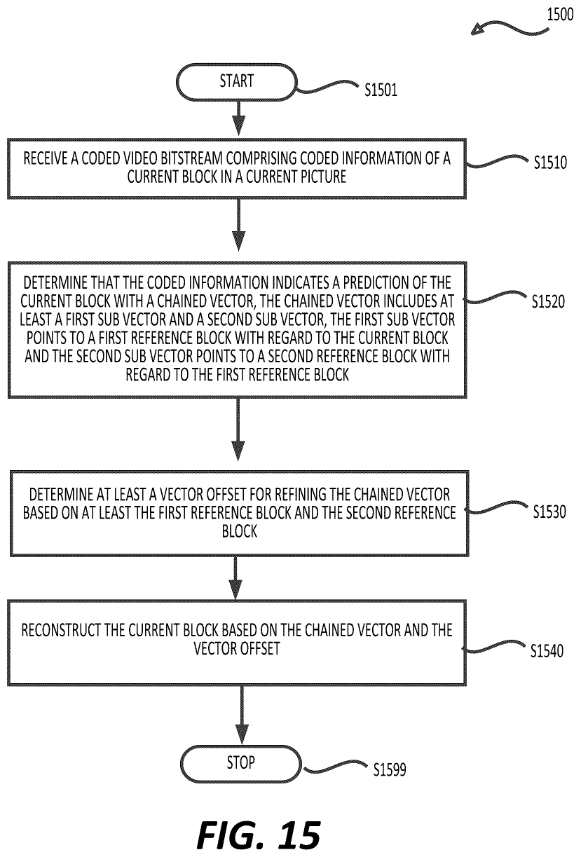

FIG. 15 shows a flow chart outlining a process (1500) according to an aspect of the disclosure. The process (1500) can be used in a video decoder. In various aspects, the process (1500) is executed by processing circuitry, such as the processing circuitry that performs functions of the video decoder (110), the processing circuitry that performs functions of the video decoder (210), and the like. In some aspects, the process (1500) is implemented in software instructions, thus when the processing circuitry executes the software instructions, the processing circuitry performs the process (1500). The process starts at (S1501) and proceeds to (S1510).

At (S1510), a coded video bitstream is received. The coded video bitstream includes coded information of a current block in a current picture.

At (S1520), it is determined that the coded information indicates a prediction of the current block with a chained vector. The chained vector includes at least a first sub vector and a second sub vector, the first sub vector points to a first reference block with regard to the current block and the second sub vector points to a second reference block with regard to the first reference block.

At (S1530), at least a vector offset for refining the chained vector is determined based on at least the first reference block and the second reference block.

At (S1540), the current block is reconstructed based on the chained vector and the vector offset.

In some aspects, the chained vector is at least one of a chained motion vector and a chained block vector.

According to an aspect of the disclosure, the chained vector is a chained motion vector that includes at least a first sub motion vector and a second sub motion vector, the first sub motion vector points to the first reference block in a first reference picture with regard to the current block, the second sub motion vector points to the second reference block in a second reference picture with regard to the first reference block. In some examples, a search range of potential motion vector offsets can be searched. Cost values associated with the potential motion vector offsets are calculated based on at least the first reference block in the first reference picture and the second reference block in the second reference picture. Then, a motion vector offset is determined based on the cost values associated with the potential motion vector offsets. For example, a potential motion vector with the lowest cost value is selected as the motion vector offset.

In some examples, the first reference picture and the second reference picture are on a same side of the current picture in a display order. To calculate the cost values, in an example, a potential motion vector offset is applied to the first reference block to obtain a first potential refined reference block in the first reference picture, and the potential motion vector offset is applied to the second reference block to obtain a second potential refined reference block in the second reference picture. A cost value associated with the potential motion vector offset is calculated based on differences between the first potential refined reference block and the second potential refined reference block.

In some examples, the first reference picture and the second reference picture are on different sides of the current picture in a display order. To calculate the cost values, in an example, a potential motion vector offset is applied to the first reference block to obtain a first potential refined reference block in the first reference picture, an opposite of the potential motion vector offset is applied to the second reference block to obtain a second potential refined reference block in the second reference picture. A cost value associated with the potential motion vector offset is calculated based on differences between the first potential refined reference block and the second potential refined reference block.

In some aspects, the coded information indicates a bi-prediction of the current block with a first motion vector and a second motion vector, and at least one of the first motion vector and the second motion vector being a chained motion vector.

In some examples, the first motion vector is a first chained motion vector in a first direction in a display order, and the second motion vector is a second chained motion vector in a second direction in the display order, the first chained motion vector points to a first reference block in a first reference picture and a second reference block in a second reference picture, the second chained motion vector points to a third reference block in a third reference picture and a fourth reference block in a fourth reference picture. Further, a first motion vector offset for the first chained motion vector is determined based on the first reference block in the first reference picture and the second reference block in the second reference picture; a second motion vector offset for the second chained motion vector is determined based on the third reference block in the third reference picture and the fourth reference block in the fourth reference picture. In an example, a first prediction of the current block is generated based on the first chained motion vector with the first motion vector offset; a second prediction of the current block is generated based on the second chained motion vector with the second motion vector offset. The current block is reconstructed based on the first prediction and the second prediction.

In some examples, cost values associated with potential motion vector offsets are calculated based on the first reference block in the first reference picture, the second reference block in the second reference picture, the third reference block in the third reference picture and the fourth reference block in the fourth reference picture, and a motion vector offset is selected from the potential motion vector offsets based on the cost values. A first prediction of the current block is generated based on the first chained motion vector with the motion vector offset. A second prediction of the current block is generated based on the second chained motion vector with an opposite of the motion vector offset. The current block is reconstructed based on the first prediction and the second prediction.

In an example, to calculating the cost values, for a potential motion vector offset in the potential motion vector offsets, the potential motion vector offset is respectively applied to the first reference block and the second reference block to respectively obtain a first potential refined reference block and a second potential refined reference block, and a first sub cost value is calculated based on differences between the first potential refined reference block and the second potential refined reference block. Also, an opposite of the potential motion vector offset is applied respectively to the third reference block and the fourth reference block to respectively obtain a third potential refined reference block and a fourth potential refined reference block, and a second sub cost value is calculated based on differences between the third potential refined reference block and the fourth potential refined reference block. A cost value associated with the potential motion vector offset is calculated as a sum of the first sub cost value and the second sub cost value.

In some examples, to refine the chained vector is determined when at least one of a block shape and a block size satisfies a requirement. In some examples, to refine the chained vector is determined when a difference between the first reference block and the second reference block satisfies a requirement.

Then, the process proceeds to (S1599) and terminates.

The process (1500) can be suitably adapted. Step(s) in the process (1500) can be modified and/or omitted. Additional step(s) can be added. Any suitable order of implementation can be used.

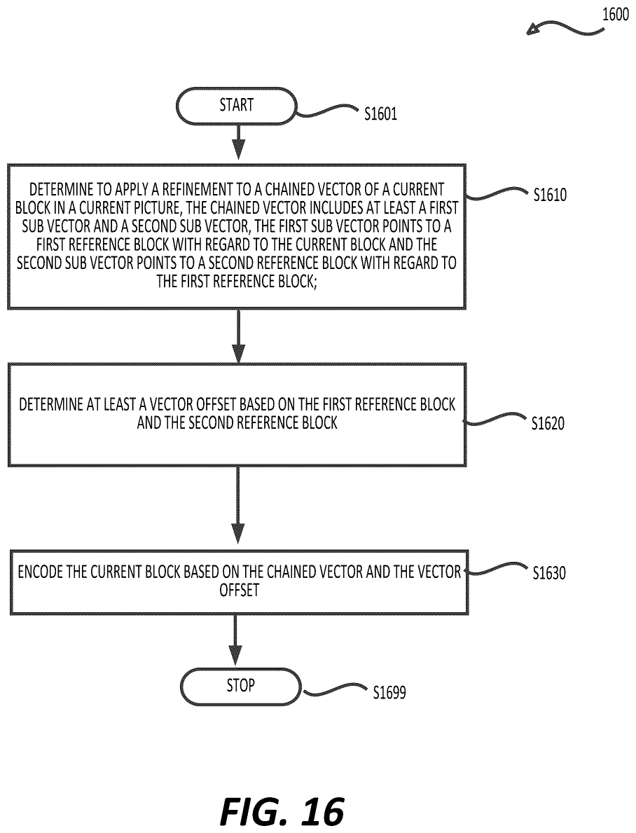

FIG. 16 shows a flow chart outlining a process (1600) according to an aspect of the disclosure. The process (1600) can be used in a video encoder. In various aspects, the process (1600) is executed by processing circuitry, such as the processing circuitry that performs functions of the video encoder (103), the processing circuitry that performs functions of the video encoder (303), and the like. In some aspects, the process (1600) is implemented in software instructions, thus when the processing circuitry executes the software instructions, the processing circuitry performs the process (1600). The process starts at (S1601) and proceeds to (S1610).

At (S1610), to apply a refinement to a chained vector of a current block in a current picture is determined. The chained vector includes at least a first sub vector and a second sub vector, the first sub vector points to a first reference block with regard to the current block and the second sub vector points to a second reference block with regard to the first reference block.

At (S1620), at least a vector offset is determined based on the first reference block and the second reference block.

At (S1630), the current block is encoded based on the chained vector and the vector offset.

It is noted that the chained vector is at least one of a chained motion vector and a chained block vector.

In some aspects, the chained vector is a chained motion vector that includes at least a first sub motion vector and a second sub motion vector, the first sub motion vector points to the first reference block in a first reference picture with regard to the current block, the second sub motion vector points to the second reference block in a second reference picture with regard to the first reference block. To determine the vector offset, in some examples, a search range of potential motion vector offsets can be searched, cost values respectively associated with the potential motion vector offsets are calculated based on at least the first reference block in the first reference picture and the second reference block in the second reference picture. A motion vector offset is determined based on the cost values associated with the potential motion vector offsets.

In some examples, the first reference picture and the second reference picture are on a same side of the current picture in a display order. To calculate the cost values, in an example, a potential motion vector offset is applied to the first reference block to obtain a first potential refined reference block in the first reference picture, and the potential motion vector offset is applied to the second reference block to obtain a second potential refined reference block in the second reference picture. A cost value associated with the potential motion vector offset is calculated based on differences between the first potential refined reference block and the second potential refined reference block.

In some examples, the first reference picture and the second reference picture are on different sides of the current picture in a display order. To calculate the cost values, in an example, a potential motion vector offset is applied to the first reference block to obtain a first potential refined reference block in the first reference picture, and an opposite of the potential motion vector offset is applied to the second reference block to obtain a second potential refined reference block in the second reference picture. A cost value associated with the potential motion vector offset is calculated based on differences between the first potential refined reference block and the second potential refined reference block.

In some examples, to encode the current block using a bi-prediction with a first motion vector and a second motion vector is determined, and at least one of the first motion vector and the second motion vector being a chained motion vector.

In some examples, the first motion vector is a first chained motion vector in a first direction in a display order, and the second motion vector is a second chained motion vector in a second direction in the display order, the first chained motion vector points to a first reference block in a first reference picture and a second reference block in a second reference picture, the second chained motion vector points to a third reference block in a third reference picture and a fourth reference block in a fourth reference picture. In some examples, a first motion vector offset for the first chained motion vector is determined based on the first reference block in the first reference picture and the second reference block in the second reference picture, and a second motion vector offset for the second chained motion vector is determined based on the third reference block in the third reference picture and the fourth reference block in the fourth reference picture. A first prediction of the current block is generated based on the first chained motion vector with the first motion vector offset, a second prediction of the current block is generated based on the second chained motion vector with the second motion vector offset. The bi-prediction of the current block is performed based on the first prediction and the second prediction.

In some examples, cost values associated with potential motion vector offsets are calculated based on the first reference block in the first reference picture, the second reference block in the second reference picture, the third reference block in the third reference picture and the fourth reference block in the fourth reference picture. A motion vector offset is selected from the potential motion vector offsets based on the cost values. A first prediction of the current block is generated based on the first chained motion vector with the motion vector offset. A second prediction of the current block is generated based on the second chained motion vector with an opposite of the motion vector offset. The bi-prediction of the current block is performed based on the first prediction and the second prediction.

To calculate the cost values, in some examples, for a potential motion vector offset in the potential motion vector offsets, the potential motion vector offset is respectively to the first reference block and the second reference block to respectively obtain a first potential refined reference block and a second potential refined reference block, and a first sub cost value is calculated based on differences between the first potential refined reference block and the second potential refined reference block. Also, an opposite of the potential motion vector offset is respectively to the third reference block and the fourth reference block to respectively obtain a third potential refined reference block and a fourth potential refined reference block, and a second sub cost value is calculated based on differences between the third potential refined reference block and the fourth potential refined reference block. Then, a cost value associated with the potential motion vector offset is calculated as a sum of the first sub cost value and the second sub cost value.

In an example, to refine the chained vector is determined when at least one of a block shape and a block size satisfies a requirement. In another example, to refine the chained vector is determined when a difference between the first reference block and the second reference block satisfies a requirement.

Then, the process proceeds to (S1699) and terminates.

The process (1600) can be suitably adapted. Step(s) in the process (1600) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream includes coded information of a current block in a current picture, the coded information of the current block indicates a prediction of the current block based on a chained vector, the chained vector includes at least a first sub vector and a second sub vector, the first sub vector points to a first reference block with regard to the current block and the second sub vector points to a second reference block with regard to the first reference block. The format rule specifies that at least a vector offset is determined based on the first reference block and the second reference block; and the current block is reconstructed based on the chained vector and the vector offset.

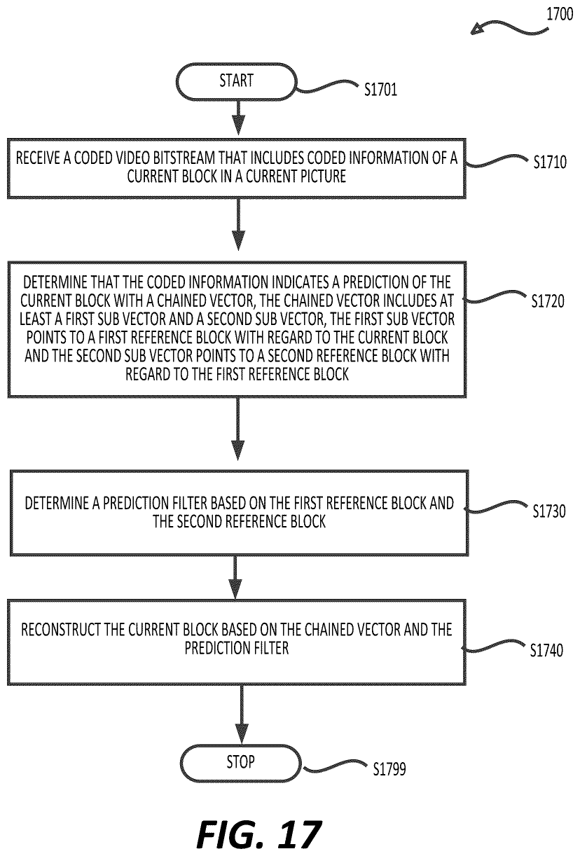

FIG. 17 shows a flow chart outlining a process (1700) according to an aspect of the disclosure. The process (1700) can be used in a video decoder. In various aspects, the process (1700) is executed by processing circuitry, such as the processing circuitry that performs functions of the video decoder (110), the processing circuitry that performs functions of the video decoder (210), and the like. In some aspects, the process (1700) is implemented in software instructions, thus when the processing circuitry executes the software instructions, the processing circuitry performs the process (1700). The process starts at (S1701) and proceeds to (S1710).

At (S1710), a coded video bitstream is received. The coded video bitstream includes coded information of a current block in a current picture.

At (S1720), the coded information is determined to indicate a prediction of the current block with a chained vector, the chained vector includes at least a first sub vector and a second sub vector, the first sub vector points to a first reference block with regard to the current block and the second sub vector points to a second reference block with regard to the first reference block.

At (S1730), a prediction filter is determined based on the first reference block and the second reference block.

At (S1740), the current block is reconstructed based on the chained vector and the prediction filter.

In some aspects, filter cost values associated with a plurality of predefined filters in a predefined filter set are calculated. The prediction filter is selected from the predefined filter set based on the filter cost values.

In some examples, the predefined filter set includes at least one of a linear filter, a non-linear filter, a sharpening filter, a smooth filter, a bilateral filter; and/or a regression-based filter derived from the first reference block and the second reference block.

In some examples, a no filter cost value is calculated based on differences between the first reference block and the second reference block without applying the plurality of predefined filters. Not to apply the plurality of predefined filters is determined when the no filter cost value is lower than each of the filter cost values.

In some examples, to calculate the filter cost values, for a predefined filter in the plurality of predefined filters, the predefined filter is applied on the second reference block to generate a filtered second reference block, and a filter cost value associated with the predefined filter is calculated based on differences between the first reference block and the filtered second reference block.

In some aspects, the coded information indicates a bi-prediction of the current block with a first chained motion vector and a second chained motion vector, the first chained motion vector points to a first reference block in a first reference picture and a second reference block in a second reference picture, the second chained motion vector points to a third reference block in a third reference picture and a fourth reference block in a fourth reference picture. In some examples, a first prediction filter is determined based on the first reference block and the second reference block, and a second prediction filter is determined based on a third reference block and the fourth reference block. The current block is reconstructed based on the first prediction filter and the second prediction filter.

In an example, to determine the first prediction filter, first filter cost values associated with a plurality of predefined filters are calculated based on the first reference block and the second reference block. The first prediction filter is selected from the plurality of predefined filters based on the first filter cost values associated with the plurality of predefined filters. In another example, to determine the second prediction filter, second filter cost values associated with the plurality of predefined filters are calculated based on the third reference block and the fourth reference block, the second prediction filter is selected from the plurality of predefined filters based on the second filter cost values associated with the plurality of predefined filters.

In some examples, filter cost values associated with a plurality of predefined filters are calculated based on the first reference block, the second reference block, a third reference block and a fourth reference block. The prediction filter is selected from the plurality of predefined filters based on the filter cost values associated with the plurality of predefined filters. The current block is reconstructed based on the prediction filter.

To calculate the filter cost values, in some examples, for a predefined filter in the plurality of predefined filters, the predefined filter is applied on the second reference block to generate a filtered second reference block, a first cost value is calculated based on differences between the first reference block and the filtered second reference block. Further, the predefined filter is applied on the fourth reference block to generate a filtered fourth reference block, and a second cost value is calculated based on differences between the third reference block and the filtered fourth reference block. A sum of the first cost value with the second cost value is calculated as a filter cost value associated with the predefined filter.

In some aspects, the prediction filter is derived using a linear regression according to the first reference block and the second reference block.

In some examples, a first prediction filter is derived using a linear regression according to the first reference block in a first reference picture and the second reference block in a second reference picture. The first prediction filter is scaled based on a ratio of a first distance and a second distance to obtain the prediction filter, the first distance is a distance between the first reference picture and the second reference picture, the second distance is a distance between the current picture and the second reference picture.

In an example, to reconstruct the current block, a motion compensation is applied on the second reference block to obtain a motion compensated block, and the prediction filter is applied on the motion compensated block to generate a prediction block of the current block.

In an example, to reconstruct the current block, the prediction filter is applied on the second reference block to obtain a filtered block of the current block, and a motion compensation is applied on the filtered block to generate a prediction block of the current block.

In an example, to reconstruct the current block, an interpolation filter is applied on the second reference block to obtain an intermediate block, and the prediction filter is applied on the intermediate block to generate a prediction block of the current block.

In an example, to reconstruct the current block, the prediction filter is applied on the second reference block to obtain an intermediate block of the current block, and an interpolation filter is applied on the intermediate block to generate a prediction block of the current block.

Then, the process proceeds to (S1799) and terminates.

The process (1700) can be suitably adapted. Step(s) in the process (1700) can be modified and/or omitted. Additional step(s) can be added. Any suitable order of implementation can be used.

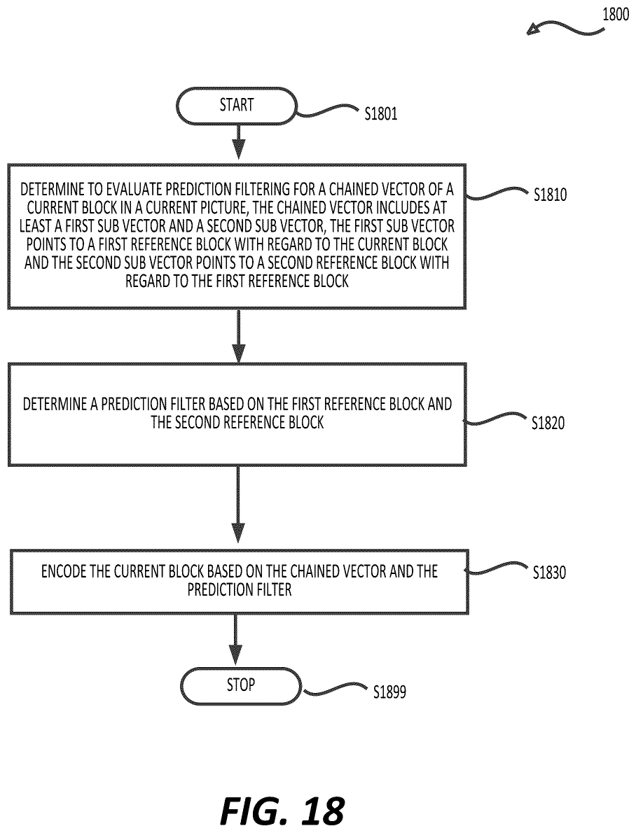

FIG. 18 shows a flow chart outlining a process (1800) according to an aspect of the disclosure. The process (1800) can be used in a video encoder. In various aspects, the process (1800) is executed by processing circuitry, such as the processing circuitry that performs functions of the video encoder (103), the processing circuitry that performs functions of the video encoder (303), and the like. In some aspects, the process (1800) is implemented in software instructions, thus when the processing circuitry executes the software instructions, the processing circuitry performs the process (1800). The process starts at (S1801) and proceeds to (S1810).

At (S1810), to evaluate prediction filtering for a chained vector of a current block in a current picture is determined. The chained vector includes at least a first sub vector and a second sub vector, the first sub vector points to a first reference block with regard to the current block and the second sub vector points to a second reference block with regard to the first reference block.

At (S1820), a prediction filter is determined based on the first reference block and the second reference block.

At (S1830), the current block is encoded based on the chained vector and the prediction filter.

In some aspects, filter cost values associated with a plurality of predefined filters in a predefined filter set are calculated. The prediction filter is selected from the predefined filter set based on the filter cost values.

In some examples, the predefined filter set includes at least one of a linear filter, a non-linear filter, a sharpening filter, a smooth filter, a bilateral filter, and/or a regression-based filter derived from the first reference block and the second reference block.

In some examples, a no filter cost value is calculated based on differences between the first reference block and the second reference block without applying the plurality of predefined filters. Not to apply the plurality of predefined filters is determined when the no filter cost value is lower than each of the filter cost values.

In some examples, to calculate the filter cost values, for a predefined filter in the plurality of predefined filters, the predefined filter is applied on the second reference block to generate a filtered second reference block, and a filter cost value associated with the predefined filter is calculated based on differences between the first reference block and the filtered second reference block.

In some aspects, to encode the current block by a bi-prediction with a first chained motion vector and a second chained motion vector is determined, the first chained motion vector points to a first reference block in a first reference picture and a second reference block in a second reference picture, the second chained motion vector points to a third reference block in a third reference picture and a fourth reference block in a fourth reference picture. In some examples, a first prediction filter is determined based on the first reference block and the second reference block, and a second prediction filter is determined based on a third reference block and the fourth reference block. The current block is encoded based on the first prediction filter and the second prediction filter.

In an example, to determine the first prediction filter, first filter cost values associated with a plurality of predefined filters are calculated based on the first reference block and the second reference block. The first prediction filter is selected from the plurality of predefined filters based on the first filter cost values associated with the plurality of predefined filters. In another example, to determine the second prediction filter, second filter cost values associated with the plurality of predefined filters are calculated based on the third reference block and the fourth reference block, the second prediction filter is selected from the plurality of predefined filters based on the second filter cost values associated with the plurality of predefined filters.

In some examples, filter cost values associated with a plurality of predefined filters are calculated based on the first reference block, the second reference block, a third reference block and a fourth reference block. The prediction filter is selected from the plurality of predefined filters based on the filter cost values associated with the plurality of predefined filters. The current block is encoded based on the prediction filter.

To calculate the filter cost values, in some examples, for a predefined filter in the plurality of predefined filters, the predefined filter is applied on the second reference block to generate a filtered second reference block, a first cost value is calculated based on differences between the first reference block and the filtered second reference block. Further, the predefined filter is applied on the fourth reference block to generate a filtered fourth reference block, and a second cost value is calculated based on differences between the third reference block and the filtered fourth reference block. A sum of the first cost value with the second cost value is calculated as a filter cost value associated with the predefined filter.

In some aspects, the prediction filter is derived using a linear regression according to the first reference block and the second reference block.

In some examples, a first prediction filter is derived using a linear regression according to the first reference block in a first reference picture and the second reference block in a second reference picture. The first prediction filter is scaled based on a ratio of a first distance and a second distance to obtain the prediction filter, the first distance is a distance between the first reference picture and the second reference picture, the second distance is a distance between the current picture and the second reference picture.

In an example, to encode the current block, a motion compensation is applied on the second reference block to obtain a motion compensated block, and the prediction filter is applied on the motion compensated block to generate a prediction block of the current block.

In an example, to encode the current block, the prediction filter is applied on the second reference block to obtain a filtered block of the current block, and a motion compensation is applied on the filtered block to generate a prediction block of the current block.

In an example, to encode the current block, an interpolation filter is applied on the second reference block to obtain an intermediate block, and the prediction filter is applied on the intermediate block to generate a prediction block of the current block.

In an example, to encode the current block, the prediction filter is applied on the second reference block to obtain an intermediate block of the current block, and an interpolation filter is applied on the intermediate block to generate a prediction block of the current block.

Then, the process proceeds to (S1899) and terminates.

The process (1800) can be suitably adapted. Step(s) in the process (1800) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream includes coded information of a current block in a current picture, the coded information indicates a prediction of the current block with a chained vector, the chained vector includes at least a first sub vector and a second sub vector, the first sub vector points to a first reference block with regard to the current block and the second sub vector points to a second reference block with regard to the first reference block. The format rule specifies that a prediction filter is determined based on the first reference block and the second reference block; and the current block is reconstructed based on the chained vector and the prediction filter.

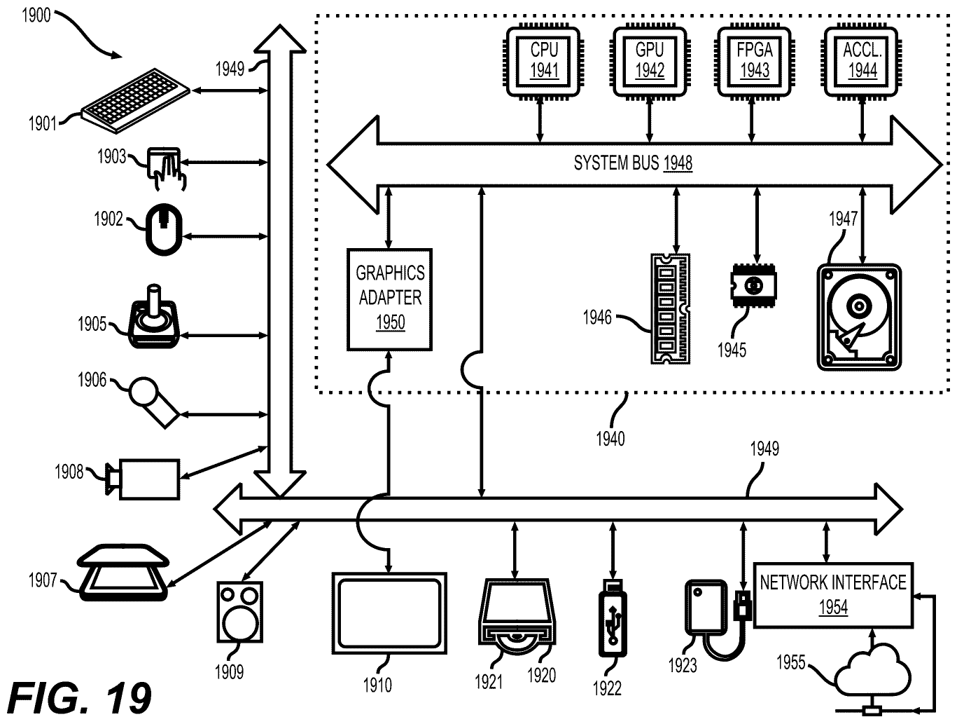

The techniques described above, can be implemented as computer software using computer-readable instructions and physically stored in one or more computer-readable media. For example, FIG. 19 shows a computer system (1900) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 19 for computer system (1900) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (1900).

Computer system (1900) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1901), mouse (1902), trackpad (1903), touch screen (1910), data-glove (not shown), joystick (1905), microphone (1906), scanner (1907), camera (1908).

Computer system (1900) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1910), data-glove (not shown), or joystick (1905), but there can also be tactile feedback devices that do not serve as input devices), audio output devices (such as: speakers (1909), headphones (not depicted)), visual output devices (such as screens (1910) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1900) can also include human accessible storage devices and their associated media such as optical media including CD/DVD ROM/RW (1920) with CD/DVD or the like media (1921), thumb-drive (1922), removable hard drive or solid state drive (1923), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1900) can also include an interface (1954) to one or more communication networks (1955). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1949) (such as, for example USB ports of the computer system (1900)); others are commonly integrated into the core of the computer system (1900) by attachment to a system bus as described below (for example Ethernet interface into a PC computer system or cellular network interface into a smartphone computer system). Using any of these networks, computer system (1900) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1940) of the computer system (1900).

The core (1940) can include one or more Central Processing Units (CPU) (1941), Graphics Processing Units (GPU) (1942), specialized programmable processing units in the form of Field Programmable Gate Areas (FPGA) (1943), hardware accelerators for certain tasks (1944), graphics adapters (1950), and so forth. These devices, along with Read-only memory (ROM) (1945), Random-access memory (1946), internal mass storage such as internal non-user accessible hard drives, SSDs, and the like (1947), may be connected through a system bus (1948). In some computer systems, the system bus (1948) can be accessible in the form of one or more physical plugs to enable extensions by additional CPUs, GPU, and the like. The peripheral devices can be attached either directly to the core's system bus (1948), or through a peripheral bus (1949). In an example, the screen (1910) can be connected to the graphics adapter (1950). Architectures for a peripheral bus include PCI, USB, and the like.

CPUs (1941), GPUs (1942), FPGAs (1943), and accelerators (1944) can execute certain instructions that, in combination, can make up the aforementioned computer code. That computer code can be stored in ROM (1945) or RAM (1946). Transitional data can also be stored in RAM (1946), whereas permanent data can be stored for example, in the internal mass storage (1947). Fast storage and retrieve to any of the memory devices can be enabled through the use of cache memory, that can be closely associated with one or more CPU (1941), GPU (1942), mass storage (1947), ROM (1945), RAM (1946), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1900), and specifically the core (1940) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1940) that are of non-transitory nature, such as core-internal mass storage (1947) or ROM (1945). The software implementing various aspects of the present disclosure can be stored in such devices and executed by core (1940). A computer-readable medium can include one or more memory devices or chips, according to particular needs. The software can cause the core (1940) and specifically the processors therein (including CPU, GPU, FPGA, and the like) to execute particular processes or particular parts of particular processes described herein, including defining data structures stored in RAM (1946) and modifying such data structures according to the processes defined by the software. In addition or as an alternative, the computer system can provide functionality as a result of logic hardwired or otherwise embodied in a circuit (for example: accelerator (1944)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.
(1). A method of video decoding, including: receiving a coded video bitstream including coded information of a current block in a current picture; determining that the coded information indicates a prediction of the current block with a chained vector, the chained vector including at least a first sub vector and a second sub vector, the first sub vector pointing to a first reference block with regard to the current block and the second sub vector pointing to a second reference block with regard to the first reference block; determining at least a vector offset for refining the chained vector based on at least the first reference block and the second reference block; and reconstructing the current block based on the chained vector and the vector offset.
(2). The method of feature (1), in which the chained vector is at least one of a chained motion vector and a chained block vector.
(3). The method of any of features (1) to (2), in which the chained vector is a chained motion vector that includes at least a first sub motion vector and a second sub motion vector, the first sub motion vector points to the first reference block in a first reference picture with regard to the current block, the second sub motion vector points to the second reference block in a second reference picture with regard to the first reference block, and the determining the vector offset includes: searching in a search range of potential motion vector offsets; calculating cost values associated with the potential motion vector offsets based on at least the first reference block in the first reference picture and the second reference block in the second reference picture; and determining a motion vector offset based on the cost values associated with the potential motion vector offsets.
(4). The method of any of features (1) to (3), in which the first reference picture and the second reference picture are on a same side of the current picture in a display order, the calculating includes: applying a potential motion vector offset to the first reference block to obtain a first potential refined reference block in the first reference picture; applying the potential motion vector offset to the second reference block to obtain a second potential refined reference block in the second reference picture; and calculating a cost value associated with the potential motion vector offset based on differences between the first potential refined reference block and the second potential refined reference block.
(5) The method of any of features (1) to (4), in which the first reference picture and the second reference picture are on different sides of the current picture in a display order, the calculating includes: applying a potential motion vector offset to the first reference block to obtain a first potential refined reference block in the first reference picture; applying an opposite of the potential motion vector offset to the second reference block to obtain a second potential refined reference block in the second reference picture; and calculating a cost value associated with the potential motion vector offset based on differences between the first potential refined reference block and the second potential refined reference block.
(6). The method of any of features (1) to (5), in which the determining that the coded information indicates the prediction of the current block with the chained vector further includes: determining that the coded information indicates a bi-prediction of the current block with a first motion vector and a second motion vector, and at least one of the first motion vector and the second motion vector being a chained motion vector.
(7). The method of any of features (1) to (6), in which the first motion vector is a first chained motion vector in a first direction in a display order, and the second motion vector is a second chained motion vector in a second direction in the display order, the first chained motion vector points to a first reference block in a first reference picture and a second reference block in a second reference picture, the second chained motion vector points to a third reference block in a third reference picture and a fourth reference block in a fourth reference picture, the method includes: determining a first motion vector offset for the first chained motion vector based on the first reference block in the first reference picture and the second reference block in the second reference picture; determining a second motion vector offset for the second chained motion vector based on the third reference block in the third reference picture and the fourth reference block in the fourth reference picture; generating a first prediction of the current block based on the first chained motion vector with the first motion vector offset; generating a second prediction of the current block based on the second chained motion vector with the second motion vector offset; and reconstructing the current block based on the first prediction and the second prediction.
(8). The method of any of features (1) to (7), in which the first motion vector is a first chained motion vector in a first direction in a display order, and the second motion vector is a second chained motion vector in a second direction in the display order, the first chained motion vector points to a first reference block in a first reference picture and a second reference block in a second reference picture, the second chained motion vector points to a third reference block in a third reference picture and a fourth reference block in a fourth reference picture, the method includes: calculating cost values associated with potential motion vector offsets based on the first reference block in the first reference picture, the second reference block in the second reference picture, the third reference block in the third reference picture and the fourth reference block in the fourth reference picture; determining a motion vector offset from the potential motion vector offsets based on the cost values; generating a first prediction of the current block based on the first chained motion vector with the motion vector offset; generating a second prediction of the current block based on the second chained motion vector with an opposite of the motion vector offset; and reconstructing the current block based on the first prediction and the second prediction.
(9). The method of any of features (1) to (8), in which the calculating the cost values includes: for a potential motion vector offset in the potential motion vector offsets: applying the potential motion vector offset respectively to the first reference block and the second reference block to respectively obtain a first potential refined reference block and a second potential refined reference block; calculating a first sub cost value based on differences between the first potential refined reference block and the second potential refined reference block; applying an opposite of the potential motion vector offset respectively to the third reference block and the fourth reference block to respectively obtain a third potential refined reference block and a fourth potential refined reference block; calculating a second sub cost value based on differences between the third potential refined reference block and the fourth potential refined reference block; and calculating a cost value associated with the potential motion vector offset as a sum of the first sub cost value and the second sub cost value.
(10). The method of any of features (1) to (9), further including at least one of: determining to refine the chained vector when at least one of a block shape and a block size satisfies a requirement; and/or determining to refine the chained vector when a difference between the first reference block and the second reference block satisfies a requirement.
(11). A method of video encoding, including: determining to apply a refinement to a chained vector of a current block in a current picture, the chained vector including at least a first sub vector and a second sub vector, the first sub vector pointing to a first reference block with regard to the current block and the second sub vector pointing to a second reference block with regard to the first reference block; determining at least a vector offset based on the first reference block and the second reference block; and encoding the current block based on the chained vector and the vector offset.
(12). The method of feature (11), in which the chained vector is at least one of a chained motion vector and a chained block vector.
(13). The method of any of features (11) to (12), in which the chained vector is a chained motion vector that includes at least a first sub motion vector and a second sub motion vector, the first sub motion vector points to the first reference block in a first reference picture with regard to the current block, the second sub motion vector points to the second reference block in a second reference picture with regard to the first reference block, and the determining the vector offset includes: searching in a search range of potential motion vector offsets; calculating cost values respectively associated with the potential motion vector offsets based on at least the first reference block in the first reference picture and the second reference block in the second reference picture; and determining a motion vector offset based on the cost values associated with the potential motion vector offsets.
(14). The method of any of features (11) to (13), in which the first reference picture and the second reference picture are on a same side of the current picture in a display order, the calculating includes: applying a potential motion vector offset to the first reference block to obtain a first potential refined reference block in the first reference picture; applying the potential motion vector offset to the second reference block to obtain a second potential refined reference block in the second reference picture; and calculating a cost value associated with the potential motion vector offset based on differences between the first potential refined reference block and the second potential refined reference block.
(15). The method of any of features (11) to (14), in which the first reference picture and the second reference picture are on different sides of the current picture in a display order, the calculating includes: applying a potential motion vector offset to the first reference block to obtain a first potential refined reference block in the first reference picture; applying an opposite of the potential motion vector offset to the second reference block to obtain a second potential refined reference block in the second reference picture; and calculating a cost value associated with the potential motion vector offset based on differences between the first potential refined reference block and the second potential refined reference block.
(16). The method of any of features (11) to (15), further including: determining to encode the current block using a bi-prediction with a first motion vector and a second motion vector, and at least one of the first motion vector and the second motion vector being a chained motion vector.
(17). The method of any of features (11) to (16), in which the first motion vector is a first chained motion vector in a first direction in a display order, and the second motion vector is a second chained motion vector in a second direction in the display order, the first chained motion vector points to a first reference block in a first reference picture and a second reference block in a second reference picture, the second chained motion vector points to a third reference block in a third reference picture and a fourth reference block in a fourth reference picture, the method includes: determining a first motion vector offset for the first chained motion vector based on the first reference block in the first reference picture and the second reference block in the second reference picture; determining a second motion vector offset for the second chained motion vector based on the third reference block in the third reference picture and the fourth reference block in the fourth reference picture; generating a first prediction of the current block based on the first chained motion vector with the first motion vector offset; generating a second prediction of the current block based on the second chained motion vector with the second motion vector offset; and performing the bi-prediction of the current block based on the first prediction and the second prediction.
(18). The method of any of features (11) to (17), in which the first motion vector is a first chained motion vector in a first direction in a display order, and the second motion vector is a second chained motion vector in a second direction in the display order, the first chained motion vector points to a first reference block in a first reference picture and a second reference block in a second reference picture, the second chained motion vector points to a third reference block in a third reference picture and a fourth reference block in a fourth reference picture, the method includes: calculating cost values associated with potential motion vector offsets based on the first reference block in the first reference picture, the second reference block in the second reference picture, the third reference block in the third reference picture and the fourth reference block in the fourth reference picture; determining a motion vector offset from the potential motion vector offsets based on the cost values; generating a first prediction of the current block based on the first chained motion vector with the motion vector offset; generating a second prediction of the current block based on the second chained motion vector with an opposite of the motion vector offset; and performing the bi-prediction of the current block based on the first prediction and the second prediction.
(19). The method of any of features (11) to (18), in which the calculating the cost values includes: for a potential motion vector offset in the potential motion vector offsets: applying the potential motion vector offset respectively to the first reference block and the second reference block to respectively obtain a first potential refined reference block and a second potential refined reference block; calculating a first sub cost value based on differences between the first potential refined reference block and the second potential refined reference block; applying an opposite of the potential motion vector offset respectively to the third reference block and the fourth reference block to respectively obtain a third potential refined reference block and a fourth potential refined reference block; calculating a second sub cost value based on differences between the third potential refined reference block and the fourth potential refined reference block; and calculating a cost value associated with the potential motion vector offset as a sum of the first sub cost value and the second sub cost value.
(20). The method of any of features (11) to (19), further including at least one of: determining to refine the chained vector when at least one of a block shape and a block size satisfies a requirement; and/or determining to refine the chained vector when a difference between the first reference block and the second reference block satisfies a requirement.
(21). A method of video decoding, including: receiving a coded video bitstream including coded information of a current block in a current picture; determining that the coded information indicates a prediction of the current block with a chained vector, the chained vector including at least a first sub vector and a second sub vector, the first sub vector pointing to a first reference block with regard to the current block and the second sub vector pointing to a second reference block with regard to the first reference block; determining a prediction filter based on the first reference block and the second reference block; and reconstructing the current block based on the chained vector and the prediction filter.
(22). The method of feature (21), in which the determining the prediction filter includes: calculating filter cost values associated with a plurality of predefined filters in a predefined filter set; and selecting the prediction filter from the predefined filter set based on the filter cost values.
(23). The method of any of features (21) to (22), in which the predefined filter set includes at least one of: a linear filter; a non-linear filter; a sharpening filter; a smooth filter; a bilateral filter; and/or a regression-based filter derived from the first reference block and the second reference block.
(24). The method of any of features (21) to (23), further including: calculating a no filter cost value based on differences between the first reference block and the second reference block without applying the plurality of predefined filters; and determining not to apply the plurality of predefined filters when the no filter cost value is lower than each of the filter cost values.
(25). The method of any of features (21) to (24), in which the calculating includes: for a predefined filter in the plurality of predefined filters: applying the predefined filter on the second reference block to generate a filtered second reference block; and calculating a filter cost value associated with the predefined filter based on differences between the first reference block and the filtered second reference block.
(26). The method of any of features (21) to (25), in which the coded information indicates a bi-prediction of the current block with a first chained motion vector and a second chained motion vector, the first chained motion vector points to a first reference block in a first reference picture and a second reference block in a second reference picture, the second chained motion vector points to a third reference block in a third reference picture and a fourth reference block in a fourth reference picture, and the method includes: determining a first prediction filter based on the first reference block and the second reference block; determining a second prediction filter based on a third reference block and the fourth reference block; and reconstructing the current block based on the first prediction filter and the second prediction filter.
(27). The method of any of features (21) to (26), in which: the determining the first prediction filter includes: calculating first filter cost values associated with a plurality of predefined filters based on the first reference block and the second reference block; and selecting the first prediction filter from the plurality of predefined filters based on the first filter cost values associated with the plurality of predefined filters; and the determining the second prediction filter includes: calculating second filter cost values associated with the plurality of predefined filters based on the third reference block and the fourth reference block; and selecting the second prediction filter from the plurality of predefined filters based on the second filter cost values associated with the plurality of predefined filters.
(28). The method of any of features (21) to (27), in which the coded information indicates a bi-prediction of the current block with a first chained motion vector and a second chained motion vector, the first chained motion vector points to a first reference block in a first reference picture and a second reference block in a second reference picture, the second chained motion vector points to a third reference block in a third reference picture and a fourth reference block in a fourth reference picture, and the method includes: calculating filter cost values associated with a plurality of predefined filters based on the first reference block, the second reference block, a third reference block and a fourth reference block; selecting the prediction filter from the plurality of predefined filters based on the filter cost values associated with the plurality of predefined filters; and reconstructing the current block based on the prediction filter.
(29). The method of any of features (21) to (28), in which the calculating the filter cost values includes: for a predefined filter in the plurality of predefined filters: applying the predefined filter on the second reference block to generate a filtered second reference block; calculating a first cost value based on differences between the first reference block and the filtered second reference block; applying the predefined filter on the fourth reference block to generate a filtered fourth reference block; calculating a second cost value based on differences between the third reference block and the filtered fourth reference block; and calculating a sum of the first cost value with the second cost value as a filter cost value associated with the predefined filter.
(30). The method of any of features (21) to (29), in which the determining the prediction filter includes: deriving the prediction filter using a linear regression according to the first reference block and the second reference block.
(31). The method of any of features (21) to (30), in which the determining the prediction filter includes: deriving a first prediction filter using a linear regression according to the first reference block in a first reference picture and the second reference block in a second reference picture; and scaling the first prediction filter based on a ratio of a first distance and a second distance to obtain the prediction filter, the first distance being a distance between the first reference picture and the second reference picture, the second distance being a distance between the current picture and the second reference picture.
(32). The method of any of features (21) to (31), in which the reconstructing the current block includes: applying a motion compensation on the second reference block to obtain a motion compensated block; and applying the prediction filter on the motion compensated block to generate a prediction block of the current block.
(33). The method of any of features (21) to (32), in which the reconstructing the current block includes: applying the prediction filter on the second reference block to obtain a filtered block of the current block; and applying a motion compensation on the filtered block to generate a prediction block of the current block.
(34). The method of any of features (21) to (33), in which the reconstructing the current block includes: applying an interpolation filter on the second reference block to obtain an intermediate block; and applying the prediction filter on the intermediate block to generate a prediction block of the current block.
(35). The method of any of features (21) to (34), in which the reconstructing the current block includes: applying the prediction filter on the second reference block to obtain an intermediate block of the current block; and applying an interpolation filter on the intermediate block to generate a prediction block of the current block.
(36). A method of video encoding, including: determining to evaluate prediction filtering for a chained vector of a current block in a current picture, the chained vector including at least a first sub vector and a second sub vector, the first sub vector pointing to a first reference block with regard to the current block and the second sub vector pointing to a second reference block with regard to the first reference block; determining a prediction filter based on the first reference block and the second reference block; and encoding the current block based on the chained vector and the prediction filter.
(37). The method of feature (36), in which the determining the prediction filter includes: calculating filter cost values associated with a plurality of predefined filters in a predefined filter set; and selecting the prediction filter from the predefined filter set based on the filter cost values.
(38). The method of any of features (36) to (37), in which the predefined filter set includes at least one of: a linear filter; a non-linear filter; a sharpening filter; a smooth filter; a bilateral filter; and/or a regression-based filter derived from the first reference block and the second reference block.
(39). The method of any of features (36) to (38), further including: calculating a no filter cost value based on differences between the first reference block and the second reference block without applying the plurality of predefined filters; and determining not to apply the plurality of predefined filters when the no filter cost value is lower than each of the filter cost values.
(40). The method of any of features (36) to (39), in which the calculating includes: for a predefined filter in the plurality of predefined filters: applying the predefined filter on the second reference block to generate a filtered second reference block; and calculating a filter cost value associated with the predefined filter based on differences between the first reference block and the filtered second reference block.
(41). The method of any of features (36) to (40), in which the current block is to be encoded by a bi-prediction with a first chained motion vector and a second chained motion vector, the first chained motion vector points to a first reference block in a first reference picture and a second reference block in a second reference picture, the second chained motion vector points to a third reference block in a third reference picture and a fourth reference block in a fourth reference picture, and the method includes: determining a first prediction filter based on the first reference block and the second reference block; determining a second prediction filter based on a third reference block and the fourth reference block; and performing the bi-prediction of the current block based on the first prediction filter and the second prediction filter.
(42). The method of any of features (36) to (41), in which: the determining the first prediction filter includes: calculating first filter cost values associated with a plurality of predefined filters based on the first reference block and the second reference block; and selecting the first prediction filter from the plurality of predefined filters based on the first filter cost values associated with the plurality of predefined filters; and the determining the second prediction filter includes: calculating second filter cost values associated with the plurality of predefined filters based on the third reference block and the fourth reference block; and selecting the second prediction filter from the plurality of predefined filters based on the second filter cost values associated with the plurality of predefined filters.
(43). The method of any of features (36) to (42), in which the current block is to be encoded by a bi-prediction with a first chained motion vector and a second chained motion vector, the first chained motion vector points to a first reference block in a first reference picture and a second reference block in a second reference picture, the second chained motion vector points to a third reference block in a third reference picture and a fourth reference block in a fourth reference picture, and the method includes: calculating filter cost values associated with a plurality of predefined filters based on the first reference block, the second reference block, a third reference block and a fourth reference block; selecting the prediction filter from the plurality of predefined filters based on the filter cost values associated with the plurality of predefined filters; and performing the bi-prediction of the current block based on the prediction filter.
(44). The method of any of features (36) to (43), in which the calculating the filter cost values includes: for a predefined filter in the plurality of predefined filters: applying the predefined filter on the second reference block to generate a filtered second reference block; calculating a first cost value based on differences between the first reference block and the filtered second reference block; applying the predefined filter on the fourth reference block to generate a filtered fourth reference block; calculating a second cost value based on differences between the third reference block and the filtered fourth reference block; and calculating a sum of the first cost value with the second cost value as a filter cost value associated with the predefined filter.
(45). The method of any of features (36) to (44), in which the determining the prediction filter includes: deriving the prediction filter using a linear regression according to the first reference block and the second reference block.
(46). The method of any of features (36) to (45), in which the determining the prediction filter includes: deriving a first prediction filter using a linear regression according to the first reference block in a first reference picture and the second reference block in a second reference picture; and scaling the first prediction filter based on a ratio of a first distance and a second distance to obtain the prediction filter, the first distance being a distance between the first reference picture and the second reference picture, the second distance being a distance between the current picture and the second reference picture.
(47). The method of any of features (36) to (46), in which the encoding the current block includes: applying a motion compensation on the second reference block to obtain a motion compensated block; applying the prediction filter on the motion compensated block to generate a prediction block of the current block; and encoding the current block based on the prediction block.
(48). The method of any of features (36) to (47), in which the encoding the current block includes: applying the prediction filter on the second reference block to obtain a filtered block of the current block; applying a motion compensation on the filtered block to generate a prediction block of the current block; and encoding the current block based on the prediction block.
(49). The method of any of features (36) to (48), in which the encoding the current block includes: applying an interpolation filter on the second reference block to obtain an intermediate block; applying the prediction filter on the intermediate block to generate a prediction block of the current block; and encoding the current block based on the prediction block.
(50). The method of any of features (36) to (49), in which the encoding the current block includes: applying the prediction filter on the second reference block to obtain an intermediate block of the current block; applying an interpolation filter on the intermediate block to generate a prediction block of the current block; and encoding the current block based on the prediction block.
(51). A method of processing visual media data, the method including: processing a bitstream of visual media data according to a format rule, in which: the bitstream includes coded information of a current block in a current picture, the coded information of the current block indicating a prediction of the current block based on a chained vector, the chained vector including at least a first sub vector and a second sub vector, the first sub vector pointing to a first reference block with regard to the current block and the second sub vector pointing to a second reference block with regard to the first reference block; and the format rule specifies that: at least a vector offset is determined based on the first reference block and the second reference block; and the current block is reconstructed based on the chained vector and the vector offset.
(52). A method of processing visual media data, the method including: processing a bitstream of visual media data according to a format rule, in which: the bitstream includes coded information of a current block in a current picture, the coded information indicating a prediction of the current block with a chained vector, the chained vector including at least a first sub vector and a second sub vector, the first sub vector pointing to a first reference block with regard to the current block and the second sub vector pointing to a second reference block with regard to the first reference block; and the format rule specifies that: a prediction filter is determined based on the first reference block and the second reference block; and the current block is reconstructed based on the prediction filter.
(53). An apparatus for video decoding, including processing circuitry that is configured to perform the method of any of features (1) to (10).
(54). An apparatus for video encoding, including processing circuitry that is configured to perform the method of any of features (11) to (20).
(55). An apparatus for video decoding, including processing circuitry that is configured to perform the method of any of features (21) to (35).
(56). An apparatus for video encoding, including processing circuitry that is configured to perform the method of any of features (36) to (50).
(57). A non-transitory computer-readable storage medium storing instructions which when executed by at least one processor cause the at least one processor to perform the method of any of features (1) to (52).

What is claimed is:

1. A method of video decoding, comprising:
receiving a coded video bitstream comprising coded information of a current block in a current picture;
determining that the coded information indicates a prediction of the current block with a chained vector, the chained vector including at least a first sub vector and a second sub vector, the first sub vector pointing to a first reference block with regard to the current block and the second sub vector pointing to a second reference block with regard to the first reference block;
determining at least a vector offset for refining the chained vector based on at least the first reference block and the second reference block; and
reconstructing the current block based on the chained vector and the vector offset.

2. The method of claim 1, wherein the chained vector is at least one of a chained motion vector and a chained block vector.

3. The method of claim 1, wherein the chained vector is a chained motion vector that includes at least a first sub motion vector and a second sub motion vector, the first sub motion vector points to the first reference block in a first reference picture with regard to the current block, the second sub motion vector points to the second reference block in a second reference picture with regard to the first reference block, and the determining the vector offset comprises:
searching in a search range of potential motion vector offsets;
calculating cost values associated with the potential motion vector offsets based on at least the first reference block in the first reference picture and the second reference block in the second reference picture; and
determining a motion vector offset based on the cost values associated with the potential motion vector offsets.

4. The method of claim 3, wherein the first reference picture and the second reference picture are on a same side of the current picture in a display order, the calculating comprises:
applying a potential motion vector offset to the first reference block to obtain a first potential refined reference block in the first reference picture;
applying the potential motion vector offset to the second reference block to obtain a second potential refined reference block in the second reference picture; and
calculating a cost value associated with the potential motion vector offset based on differences between the first potential refined reference block and the second potential refined reference block.

5. The method of claim 3, wherein the first reference picture and the second reference picture are on different sides of the current picture in a display order, the calculating comprises:
applying a potential motion vector offset to the first reference block to obtain a first potential refined reference block in the first reference picture;
applying an opposite of the potential motion vector offset to the second reference block to obtain a second potential refined reference block in the second reference picture; and
calculating a cost value associated with the potential motion vector offset based on differences between the first potential refined reference block and the second potential refined reference block.

6. The method of claim 1, wherein the determining that the coded information indicates the prediction of the current block with the chained vector further comprises:
determining that the coded information indicates a bi-prediction of the current block with a first motion vector and a second motion vector, and at least one of the first motion vector and the second motion vector being a chained motion vector.

7. The method of claim 6, wherein the first motion vector is a first chained motion vector in a first direction in a display order, and the second motion vector is a second chained motion vector in a second direction in the display order, the first chained motion vector points to a first reference block in a first reference picture and a second reference block in a second reference picture, the second chained motion vector points to a third reference block in a third reference picture and a fourth reference block in a fourth reference picture, the method comprises:
determining a first motion vector offset for the first chained motion vector based on the first reference block in the first reference picture and the second reference block in the second reference picture;
determining a second motion vector offset for the second chained motion vector based on the third reference block in the third reference picture and the fourth reference block in the fourth reference picture;
generating a first prediction of the current block based on the first chained motion vector with the first motion vector offset;
generating a second prediction of the current block based on the second chained motion vector with the second motion vector offset; and
reconstructing the current block based on the first prediction and the second prediction.

8. The method of claim 6, wherein the first motion vector is a first chained motion vector in a first direction in a display order, and the second motion vector is a second chained motion vector in a second direction in the display order, the first chained motion vector points to a first reference block in a first reference picture and a second reference block in a second reference picture, the second chained motion vector points to a third reference block in a third reference picture and a fourth reference block in a fourth reference picture, the method comprises:
calculating cost values associated with potential motion vector offsets based on the first reference block in the first reference picture, the second reference block in the second reference picture, the third reference block in the third reference picture and the fourth reference block in the fourth reference picture;
determining a motion vector offset from the potential motion vector offsets based on the cost values;
generating a first prediction of the current block based on the first chained motion vector with the motion vector offset;
generating a second prediction of the current block based on the second chained motion vector with an opposite of the motion vector offset; and
reconstructing the current block based on the first prediction and the second prediction.

9. The method of claim 8, wherein the calculating the cost values comprises:
for a potential motion vector offset in the potential motion vector offsets:
applying the potential motion vector offset respectively to the first reference block and the second reference block to respectively obtain a first potential refined reference block and a second potential refined reference block;
calculating a first sub cost value based on differences between the first potential refined reference block and the second potential refined reference block;
applying an opposite of the potential motion vector offset respectively to the third reference block and the fourth reference block to respectively obtain a third potential refined reference block and a fourth potential refined reference block;
calculating a second sub cost value based on differences between the third potential refined reference block and the fourth potential refined reference block; and
calculating a cost value associated with the potential motion vector offset as a sum of the first sub cost value and the second sub cost value.

10. The method of claim 1, further comprising at least one of:
determining to refine the chained vector when at least one of a block shape and a block size satisfies a requirement; and/or
determining to refine the chained vector when a difference between the first reference block and the second reference block satisfies a requirement.

11. A method of video encoding, comprising:
determining to apply a refinement to a chained vector of a current block in a current picture, the chained vector including at least a first sub vector and a second sub vector, the first sub vector pointing to a first reference block with regard to the current block and the second sub vector pointing to a second reference block with regard to the first reference block;
determining at least a vector offset based on the first reference block and the second reference block; and
encoding the current block based on the chained vector and the vector offset.

12. The method of claim 11, wherein the chained vector is at least one of a chained motion vector and a chained block vector.

13. The method of claim 11, wherein the chained vector is a chained motion vector that includes at least a first sub motion vector and a second sub motion vector, the first sub motion vector points to the first reference block in a first reference picture with regard to the current block, the second sub motion vector points to the second reference block in a second reference picture with regard to the first reference block, and the determining the vector offset comprises:
searching in a search range of potential motion vector offsets;
calculating cost values respectively associated with the potential motion vector offsets based on at least the first reference block in the first reference picture and the second reference block in the second reference picture; and
determining a motion vector offset based on the cost values associated with the potential motion vector offsets.

14. The method of claim 13, wherein the first reference picture and the second reference picture are on a same side of the current picture in a display order, the calculating comprises:
applying a potential motion vector offset to the first reference block to obtain a first potential refined reference block in the first reference picture;
applying the potential motion vector offset to the second reference block to obtain a second potential refined reference block in the second reference picture; and
calculating a cost value associated with the potential motion vector offset based on differences between the first potential refined reference block and the second potential refined reference block.

15. The method of claim 13, wherein the first reference picture and the second reference picture are on different sides of the current picture in a display order, the calculating comprises:
applying a potential motion vector offset to the first reference block to obtain a first potential refined reference block in the first reference picture;
applying an opposite of the potential motion vector offset to the second reference block to obtain a second potential refined reference block in the second reference picture; and
calculating a cost value associated with the potential motion vector offset based on differences between the first potential refined reference block and the second potential refined reference block.

16. The method of claim 11, further comprising:
determining to encode the current block using a bi-prediction with a first motion vector and a second motion vector, and at least one of the first motion vector and the second motion vector being a chained motion vector.

17. The method of claim 16, wherein the first motion vector is a first chained motion vector in a first direction in a display order, and the second motion vector is a second chained motion vector in a second direction in the display order, the first chained motion vector points to a first reference block in a first reference picture and a second reference block in a second reference picture, the second chained motion vector points to a third reference block in a third reference picture and a fourth reference block in a fourth reference picture, the method comprises:
determining a first motion vector offset for the first chained motion vector based on the first reference block in the first reference picture and the second reference block in the second reference picture;
determining a second motion vector offset for the second chained motion vector based on the third reference block in the third reference picture and the fourth reference block in the fourth reference picture;
generating a first prediction of the current block based on the first chained motion vector with the first motion vector offset;
generating a second prediction of the current block based on the second chained motion vector with the second motion vector offset; and
performing the bi-prediction of the current block based on the first prediction and the second prediction.

18. The method of claim 16, wherein the first motion vector is a first chained motion vector in a first direction in a display order, and the second motion vector is a second chained motion vector in a second direction in the display order, the first chained motion vector points to a first reference block in a first reference picture and a second reference block in a second reference picture, the second chained motion vector points to a third reference block in a third reference picture and a fourth reference block in a fourth reference picture, the method comprises:
calculating cost values associated with potential motion vector offsets based on the first reference block in the first reference picture, the second reference block in the second reference picture, the third reference block in the third reference picture and the fourth reference block in the fourth reference picture;
determining a motion vector offset from the potential motion vector offsets based on the cost values;
generating a first prediction of the current block based on the first chained motion vector with the motion vector offset;
generating a second prediction of the current block based on the second chained motion vector with an opposite of the motion vector offset; and
performing the bi-prediction of the current block based on the first prediction and the second prediction.

19. The method of claim 18, wherein the calculating the cost values comprises:
for a potential motion vector offset in the potential motion vector offsets:
applying the potential motion vector offset respectively to the first reference block and the second reference block to respectively obtain a first potential refined reference block and a second potential refined reference block;
calculating a first sub cost value based on differences between the first potential refined reference block and the second potential refined reference block;
applying an opposite of the potential motion vector offset respectively to the third reference block and the fourth reference block to respectively obtain a third potential refined reference block and a fourth potential refined reference block;
calculating a second sub cost value based on differences between the third potential refined reference block and the fourth potential refined reference block; and
calculating a cost value associated with the potential motion vector offset as a sum of the first sub cost value and the second sub cost value.

20. A method of processing visual media data, the method comprising:
processing a bitstream of visual media data according to a format rule, wherein:
the bitstream includes coded information of a current block in a current picture, the coded information of the current block indicating a prediction of the current block based on a chained vector, the chained vector including at least a first sub vector and a second sub vector, the first sub vector pointing to a first reference block with regard to the current block and the second sub vector pointing to a second reference block with regard to the first reference block; and
the format rule specifies that:
at least a vector offset is determined based on the first reference block and the second reference block; and
the current block is reconstructed based on the chained vector and the vector offset.
